(19) United States
(12) Patent Application Publication
(10) Pub. No.: US 2011/0170649 A1
(43) Pub. Date: Jul. 14, 2011

(54) MAGNETIC CONFINEMENT DEVICE WITH ALUMINUM OR ALUMINUM-ALLOY MAGNETS

(76) Inventors: Michael T. Kotschenreuther, Austin, TX (US); Prashant M. Valanju, Austin, TX (US); Swadesh M. Mahajan, Austin, TX (US)

(21) Appl. No.: 12/685,337

(22) Filed: Jan. 11, 2010

(51) Int. Cl. G21B 1/05

(52) U.S. Cl. 376/133

(57) ABSTRACT

Disclosed is a device comprising a chamber enclosed by walls about a central axis. The chamber has an inner radius and an outer radius relative to the central axis and is configured to magnetically contain a core plasma. The device is further comprised of a divertor plate configured for receiving exhaust heat. The divertor plate has a divertor radius relative to the central axis. The divertor radius is greater than or equal to the sum of a plasma minor radius and a major radius of the peak point closest to the corresponding divertor plate. The device can be used for containing a fusion plasma, as a compact fusion neutron source, or as a compact fusion energy source. Methods of exhausting heat from such a device when plasma is present therein are also described. This abstract is intended for use as a scanning tool only and is not intended to be limiting.

### ACKNOWLEDGEMENT

This invention was made with U.S. government support under Grant Nos. DE-FG02-04ER54742 and DE-FG02-04ER54754 awarded by the United States Department of Energy. The government has certain rights in the invention.

### BACKGROUND

Nuclear fusion is an energy source derived from nuclear combinations of light elements into heavier elements resulting in a release of energy. In fusion, two light nuclei (such as deuterium and tritium) combine into one new nucleus (such as helium) and release enormous energy and another particle (such as a neutron in the case of the fusion of deuterium and tritium) in the process. While fusion is a spectacularly successful energy source for the sun and the stars, the practicalities of harnessing fusion on Earth are technically challenging, given that to sustain fusion, a plasma (a gas consisting of charged ions and electrons), or an ionized gas, has to be confined and heated to millions of degrees Celsius in a fusion reactor for a sufficient period of time to enable the fusion reaction to occur. The science behind fusion is well advanced, rooted in more than 100 years of nuclear physics and electromagnetic and kinetic theory, yet current engineering constraints make the practical use of nuclear fusion very challenging. One approach to fusion reactors uses a powerful magnetic field to confine plasma, thereby releasing fusion energy in a controlled manner. To date, the most successful approach for achieving controlled fusion is in a donut-shape or toroidal-shape magnetic configuration called a tokamak.

The confinement of plasma to produce nuclear fusion reactions can be accomplished with a magnetic field (i.e., a magnetic bottle) created inside a vacuum chamber of a fusion reactor. Since the plasma is ionized, plasma particles tend to gyrate in small orbits around magnetic field lines, i.e., they essentially stick to the magnetic field lines, while flowing quite freely along the field lines. This can be used to “suspend” bulk plasma in the vacuum chamber by using a properly designed magnetic field configuration, which is sometimes called a magnetic bottle. The plasma can be magnetically contained within the chamber by creating a set of nested toroidal magnetic surfaces by driving an electric current in the plasma, and by the placement of current-carrying coils or conductors adjacent to the plasma. Since magnetic field lines on these magnetic surfaces do not touch any material objects such as walls of the vacuum chamber, the very hot plasma can ideally remain suspended in the magnetic bottle, i.e., in the volume containing closed magnetic surfaces, for a long time, without the particles coming into contact with the walls. However, in reality, particles and energy very slowly escape magnetic confinement in a direction perpendicular to the magnetic surfaces as a result of particle collisions with one another or turbulence in the plasma. Decreasing this slow plasma loss, so that the particles and energy of the plasma are better confined, has been a fundamental focus of plasma confinement research.

The boundary of the magnetic bottle containing closed magnetic surfaces, i.e., the “core plasma”, is defined by either material objects called limiters (e.g., 410 with reference to FIG. 4), or by a toroidal magnetic surface called a separatrix (e.g., 430 with reference to FIG. 4), outside of which the magnetic field lines are “open”, i.e., they terminate on material objects called divertor targets (e.g., 420 with reference to FIG. 4). The particles and energy slowly escaping the core plasma mainly fall on small areas of either limiter or divertor targets and generate impurities. Since limiters are right at the plasma boundary, while divertor targets can be placed farther away, core plasma can be better isolated from such impurities by using divertors. Since the invention of divertors, the preferred mode of plasma operation has been to have a separatrix and a divertor, since such operation has been found to enable a mode of operation called the H-mode, where the plasma particles and energy in the core are better confined.

Since particles flow very fast along magnetic lines but very slow across them, any particles and energy that escape across the separatrix reach divertor targets quickly along open field lines before moving much across them. This creates a necessarily narrow “scrape-off layer” with a high “scrape off flux” of particles and energy that falls on narrow areas of the divertor plates. The maximum “scrape off flux” that a divertor can handle limits the highest power density that can be sustained in a magnetic bottle.

High “scrape off flux” creates a multitude of challenges. In addition to heat and particle fluxes, the divertor plates also have to withstand large fluxes of neutrons created in fusion. These neutrons cause a degradation of many important material properties, making it extremely difficult for a divertor plate to handle both the high heat fluxes and neutron fluxes without having to be replaced frequently. Periodically replacing the damaged components is very time consuming and requires the fusion reaction to be shut off. Further, trying to reduce the “scrape off flux” by injecting impurities to radiate energy before it reaches divertor plates is not workable because the density of power coming out of the plasma becomes so high that it seriously degrades the plasma confinement, which results in a serious reduction of the fusion reaction rate in the core plasma.

To lower neutron and heat fluxes within a fusion reactor and thus mitigate the damage to a divertor component, a reactor could simply be made larger to decrease the density of power within a device. However, this approach significantly increases the reactor cost, and hence the cost of any energy produced with it, to levels that are economically non-competitive with other methods for the generation of power or neutrons.

Nuclear fusion has long been considered an energy source of the future, since the fuel supply can be as abundant as part of seawater and the carbon dioxide production per unit of energy produced can be very small. In addition to energy production, many other fusion applications have been theoretically proposed. However, there are roadblocks for these fusion applications. Therefore, what is needed are methods and devices to overcome challenges in the art, such as materials used to form magnetic fields that can better withstand the effects of nuclear fusion occurring nearby, thus providing a new method needed to overcome critical challenges in the current art of fusion.

### SUMMARY

Disclosed herein are embodiments of a device for containing plasma or fusion plasma, a compact fusion neutron source, and tokamak, optionally comprising magnetically confined plasma. Also disclosed are methods of exhausting heat from disclosed embodiments. The various embodiments described herein can be useful in applications that desire nuclear fusion, a source of neutrons and/or products produced therefrom.

In one aspect, disclosed is a fusion neutron source comprising: a toroidal chamber about a central axis, wherein a toroidal core plasma is substantially confined within the toroidal chamber by closed magnetic field lines that stay substantially on closed toroidal magnetic surfaces; said closed magnetic field lines created by currents in the core plasma and in current-carrying conductors substantially adjacent to said toroidal chamber, said current-carrying conductors comprised of aluminum or an alloy thereof, and said toroidal core plasma is substantially enclosed by a region of open magnetic field lines that intersect one or more divertor plates; said divertor plate has an outboard divertor major radius that is greater than a sum of the plasma minor radius and a major radius of a peak point closest to the corresponding divertor plate.

In a further aspect, disclosed is a toroidal plasma device. The toroidal plasma device is comprised of a toroidal chamber about a central axis. A toroidal core plasma is substantially confined within the toroidal chamber by magnetic field lines that stay substantially on closed toroidal magnetic surfaces. The magnetic field lines are created by currents in the core plasma and in current-carrying conductors substantially adjacent to the toroidal chamber, said current-carrying conductors comprised of aluminum or an alloy thereof. The toroidal core plasma is substantially enclosed by a region of open magnetic field lines that intersect one or more divertor plates. Further comprising the toroidal plasma device is a separatrix. The separatrix is comprised of a magnetic surface that separates the core plasma and the region of open magnetic field lines. The separatrix intersects the divertor plates such that particles and energy that flow from the core plasma across the separatrix into the region of open magnetic field lines are directed along the open magnetic field lines to the divertor plates. The separatrix contains at least one stagnation point with a non-zero perpendicular distance from an equatorial plane which is perpendicular to the central axis and which passes through a point at a largest major radius in the core plasma. The perpendicular distance of the stagnation point from the equatorial plane is greater than a plasma minor radius, and, the divertor plate has an outboard divertor major radius that is greater than a sum of the plasma minor radius and a major radius of a peak point closest to the corresponding divertor plate.

In one aspect, disclosed is a method of exhausting heat from a toroidal plasma device. The method comprises the steps of creating a core plasma in a toroidal chamber about a central axis. The toroidal core plasma is substantially confined within the toroidal chamber by magnetic field lines that stay substantially on closed toroidal magnetic surfaces. The magnetic field lines are created by currents in the core plasma and in current-carrying conductors substantially adjacent to said toroidal chamber, said current-carrying conductors comprised of aluminum or an alloy thereof. The toroidal core plasma is substantially enclosed by a region of open magnetic field lines that intersect one or more divertor plates. Particles from the toroidal core plasma that cross said closed magnetic field lines are directed to the open magnetic field lines to the one or more divertor plates. At least one of the one or more divertor plates is placed at an outboard divertor major radius that is greater than or equal to a sum of a plasma minor radius and a major radius of the peak point closest to the corresponding divertor plate.

Further described herein is a device comprising a chamber enclosed by walls about a central axis. The chamber has an inner radius and an outer radius relative to the central axis and is configured to magnetically contain a core plasma. The device is further comprised of a divertor plate configured for receiving exhaust heat. The divertor plate has a divertor radius relative to the central axis. The divertor radius is greater than or equal to the sum of a plasma minor radius and a major radius of the peak point closest to the corresponding divertor plate. The device has a system of coils for generating and shaping magnetic field lines, said system of coils comprising one or more coils comprised of aluminum or an alloy thereof. The device can be used for containing fusion plasma, as a compact fusion neutron source, and as a tokamak. Methods of exhausting heat from such a device when plasma is present therein are also described.

Additional advantages will be set forth in part in the description which follows, and in part will be obvious from the description, or may be learned by practice. Other advantages will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, not necessarily drawn to scale, which are incorporated in and constitute a part of this specification, illustrate several embodiments and together with the description serve to explain the principles of the invention, and in which:

FIG. 1 shows a cross-sectional upper region view of a disclosed embodiment generated by CORSICA™;

FIG. 2 shows a vessel around a central axis;

FIGS. 3A, 3B and 3C show flow charts for methods for exhausting heat from disclosed embodiments;

FIG. 4 shows a prior art magnetic confinement configuration comprising a limiter and a divertor;

FIG. 5 shows a lower region of a prior art magnetic confinement configuration comprising an X divertor, as described in Kotschenreuther et al. “On heat loading, novel divertors, and fusion reactors,” Phys. Plasmas 14, 72502/1-25 (2006);

FIG. 6 shows a modified schematic of a tokamak comprising an embodiment of a disclosed divertor;

FIG. 7A shows an upper region of CORSICA™ equilibrium for an exemplary embodiment;

FIG. 7B shows an upper region of CORSICA™ equilibrium for an exemplary embodiment, wherein the divertor coil is split into two distinct divertor coils;

FIG. 7C shows an upper region of CORSICA™ equilibrium for an exemplary embodiment, wherein the divertor coil is split into four distinct divertor coils;

FIG. 8 shows an exemplary diagram of a Fusion Development Facility (FDF) based embodiment for a disclosed FDF based reactor;

FIG. 9 shows an upper region of CORSICA™ equilibrium for an exemplary embodiment for a Component Test Facility (CTF) with Cu coils;

FIG. 10 shows an upper region of CORSICA™ equilibrium for an exemplary embodiment for a Slim-CS, a reduced size central solenoid (CS) based reactor with superconducting coils;

FIG. 11 shows upper region of CORSICA™ equilibrium for an exemplary embodiment for an ARIES (Advanced Reactor Innovation and Evaluation Study) based reactor (using modular coils that fit inside the extractable sections bounded by the dotted line);

FIGS. 12a & 12b show (a) a diagram of National High-power Advanced Torus Experiment (NHTX) based embodiment and (b) CORSICA™ equilibrium for a disclosed NHTX based reactor;

FIG. 13A shows a standard NHTX configuration (prior art);

FIG. 13B shows a SOLPS (Scrape-off Layer Plasma Simulation) calculation for an NHTX based reactor comprising an embodiment of a disclosed divertor configuration;

FIG. 13C shows upper region of CORSICA™ equilibrium for a disclosed NHTX based embodiment;

FIG. 14 shows a cross-section plot of ITER (International Thermonuclear Experimental Reactor) plasma size compared to high power density plasma sizes achievable using embodiments described herein; and

FIG. 15 is a plot showing the reduced effect of plasma motion on location of divertor strike-point for a disclosed divertor as compared to the greater effect of the same plasma motion on plasma X point.

### DETAILED DESCRIPTION

The devices, systems and methods described herein may be understood more readily by reference to the following detailed description and the examples included therein and to the figures and their previous and following description.

Before the present systems, articles, devices, and/or methods are disclosed and described, it is to be understood that this invention is not limited to specific systems, specific devices, or to particular methodology, as such may, of course, vary. It is also to be understood that the terminology used herein is for the purpose of describing particular embodiments only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the embodiments of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Although any methods and materials similar or equivalent to those described herein can be used in the practice or testing of the present invention, example methods and materials are now described.

Throughout this application, various publications are referenced. Unless otherwise noted, the disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which may need to be independently confirmed.

As used in the specification and the appended claims, the singular forms “a,” “an” and “the” include plural referents unless the context clearly dictates otherwise. Thus, for example, reference to “a divertor plate,” “a reactor,” or “a particle” includes combinations of two or more such divertor plates, reactors, or particles, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, the terms “optional” or “optionally” means that the subsequently described aspect may or may not be present or that the subsequently described event or circumstance may or may not occur, and that the description includes instances where said event or circumstance occurs and instances where it does not. For example, a disclosed embodiment can optionally comprise a fusion plasma, i.e., a fusion plasma can or cannot be present.

“Exemplary,” where used herein, means “an example of” and is not intended to convey a preferred or ideal embodiment. Further, the phrase “such as” as used herein is not intended to be restrictive in any sense, but is merely explanatory and is used to indicate that the recited items are just examples of what is covered by that provision.

Disclosed are the components to be used to prepare the compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions. Thus, if there are a variety of additional steps that can be performed it is understood that each of these additional steps can be performed with any specific embodiment or combination of embodiments of the methods.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Disclosed are vessels for containing plasma or fusion plasma, fusion neutron sources, and tokamaks, wherein a reactive plasma can optionally be present therein. Also disclosed are methods of exhausting heat from a disclosed embodiment, wherein a reactive plasma is present.

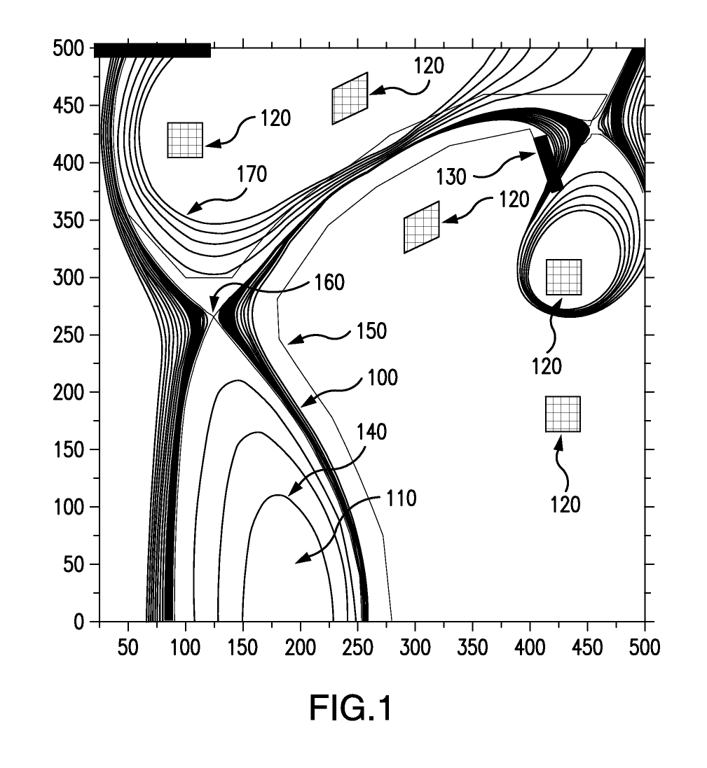

As an example, a disclosed embodiment can have a magnetic geometry and coil and divertor configuration as shown in FIG. 1, which is a cross-sectional view of a section of a toroidal reactor generated by a CORSICA™ computer program. CORSICA™ is software developed by The Lawrence Livermore National Laboratory, Livermore, Calif., for simulating physics processes in a magnetic fusion reactor. In this embodiment, core plasma 110 can be primarily confined by closed magnetic surfaces 140, wherein a scrape off layer (SOL) 100 exists beyond said closed magnetic surfaces. The closed magnetic surfaces 140 in the core plasma 110 are caused by currents driven in the core plasma 110, in poloidal field (PF) coils 120, in conductors (not shown), and in toroidal field (TF) coils (not shown) as known in the art. The SOL 100 can comprise open magnetic field lines (relative to lines on the closed magnetic surfaces 140 of the core plasma). A vacuum chamber can be substantially enclosed by walls 150. Additional magnetic field lines 170 can exist outside said vacuum chamber. PF coils 120 or current carrying conductors (not shown) in or adjacent to the walls 150 can be used to produce magnetic fields (i.e., poloidal fields (PF)) that shape the open magnetic field lines. Said coils 120 or current-carrying conductors can shape and/or control magnetic field lines if there is a need to shape and/or control said lines, and create the open magnetic field lines for diverting cross-field flux (or scrape-off flux), i.e., particles that migrate from the core plasma 110 across the closed surfaces 140 to the open magnetic field lines in the SOL 100. Scrape-off flux can be diverted by the open magnetic field lines to a divertor plate 130, which can optionally be shielded from neutrons emitted from the fusion plasma 110. Because the divertor plate 130 is at a distance (straight line distance) from the core plasma 110 and at a magnetic distance (distance along a magnetic field line from the core plasma to the divertor plate) that is greater than other fusion reactors of similar size found in the art, the open magnetic field lines can be spread further at the divertor plate, thereby mitigating heat concentration on the divertor plate 130, and allowing radiant cooling of the particle from the time it leaves the core plasma until it arrives at the divertor plate 130. Various modifications of this embodiment can be made, as will be apparent from the present disclosure.

As used herein, a “vessel for containing plasma” can be any vessel compatible with fusion, and is not necessarily limited to known vessel designs. A vessel for containing plasma can be a fusion neutron source, if a reactive plasma is present. A vessel for containing plasma can also be a tokamak. It is understood that any disclosed component or embodiment can be used with any disclosed vessel for containing plasma, fusion plasma, fusion neutron source, or tokamak, or method of exhausting heat therefrom, unless the context clearly dictates otherwise.

In one aspect, a disclosed embodiment can comprise a toroidal chamber enclosed by walls about a central axis, wherein said toroidal chamber has an inner radius and an outer radius relative to the central axis; a divertor plate for receiving exhaust heat from a fusion plasma substantially contained within the toroidal chamber by magnetic fields, said divertor plate having a divertor radius relative to the central axis and said divertor radius at least greater than or equal to a sum of the plasma minor radius and a major radius of a peak point closest to the corresponding divertor plate.

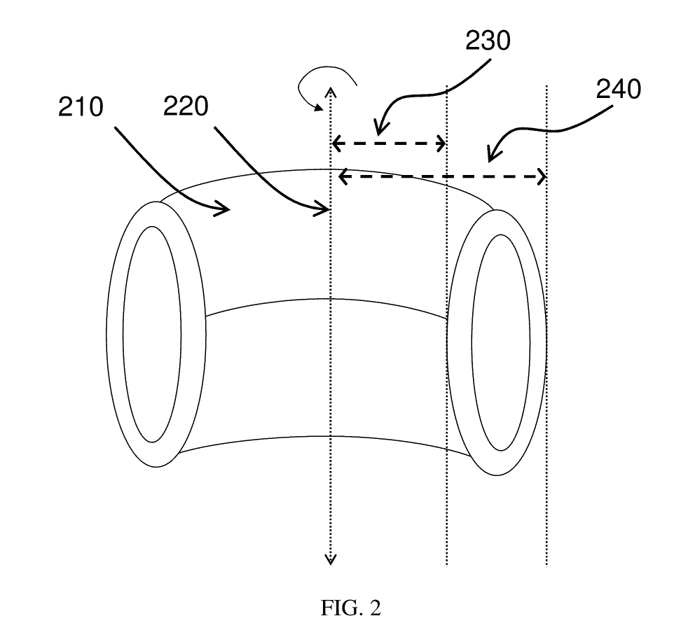

As used herein, “central axis” refers to an axis passing through the centroid of a disclosed embodiment. A portion of a vessel 210, for example, surrounding a central axis 220 is shown in FIG. 2. A point in space extending outward and substantially perpendicular to said central axis has a radius relative to said central axis. For example, said vessel can have an inner radius 230 closest to said central axis 220 and an outer radius 240 farthest from said central axis 220. In one aspect, said inner or said outer radius can be defined as a point extending from an imaginary line substantially perpendicular to said central axis 220.

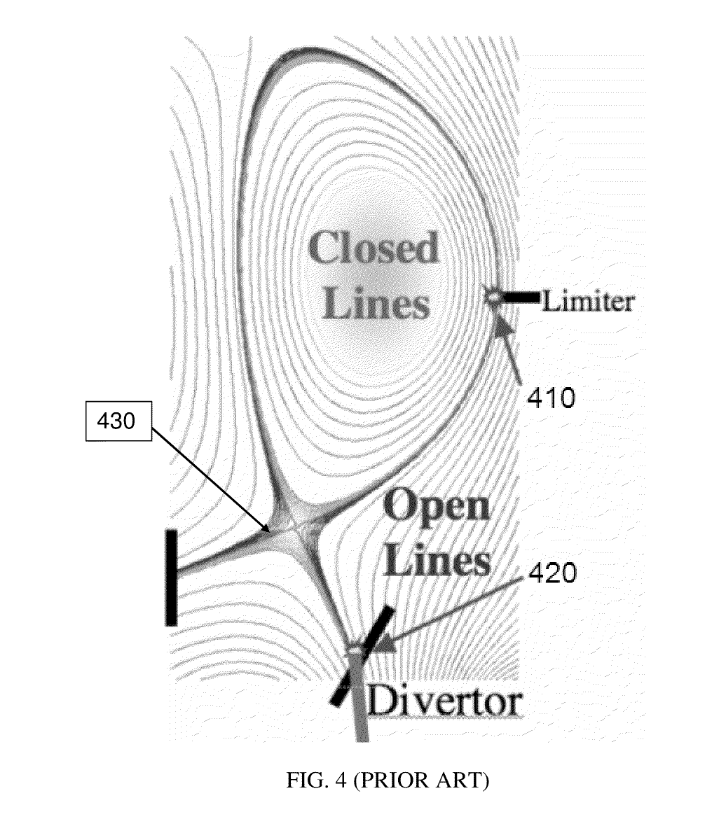

A disclosed chamber can be any shape compatible for confining fusion plasma. In some aspects, at least a portion of the disclosed chamber can be toroidal, i.e., donut-shaped. By “toroidal,” it is meant that a rotation around a central axis would be a toroidal rotation and at least a portion of the disclosed chamber would remain invariant under a toroidal rotation. Thus, in one aspect, when a Figure (such as FIGS. 1 and 4-12) shows a two-dimensional cross-section in a plane containing a central axis, the corresponding three dimensional toroidal embodiment can be reconstructed by applying a toroidal rotation of 360 degrees about said central axis.

In one aspect, a disclosed vessel can comprise any material known to be compatible with fusion reactors. Non-limiting examples include metals (e.g., tungsten and steel), metal alloys, composites, including carbon composites, combinations thereof, and the like.

In one aspect, a disclosed embodiment comprises an improved divertor. As used herein, the “divertor” is meant to refer to all aspects within an embodiment that divert heat, energy, and/or particles from the core plasma to a desired location away from the core plasma. Examples of aspects of a divertor include, but are not limited to, the scrape-off layer, separatrix, open magnetic field lines containing scrape-off flux therein, and one or more divertor plates (or divertor targets).

In one aspect, said divertor plate can comprise any material suited for use with a fusion reactor. Known existing divertor compositions can be used, such as, for example, tungsten or tungsten composite on a Cu or carbon composite. Other materials that can be used include steel alloys on a high thermal conductivity substrate.

In a further aspect, a divertor plate can have a divertor radius relative to the central axis and said divertor radius can be located at a position relative to another component or point within a disclosed embodiment. As one skilled in the art will appreciate, the ratio of the divertor radius relative to other components, e.g., the plasma or the chamber wall, etc., is intended to encompass any appropriate individual radius, and thus any actual divertor radius disclosed is meant to be purely exemplary, and as such, non-limiting.

As used herein, and represented by R_{div}, the term “divertor radius” is meant to refer to the average radial distance of the divertor plate from the central axis.

In one aspect, a divertor plate can have a divertor radius greater than or equal to about the outer radius of the toroidal chamber. In a further aspect, a divertor plate can have a divertor radius less than or equal to about the outer radius of the toroidal chamber. In a still further aspect, a divertor plate can have a divertor radius greater than or equal to about the inner radius of the toroidal chamber.

In one aspect, the ratio of the divertor radius, R_{div}, to the outer radius of the toroidal chamber, R_{c}, can be from about 0.2 to about 10, or from about 0.5 to about 8, or from about 1 to about 6, or from about 1 to about 5, or from about 1 to about 3, or from about 1 to about 2, of from about 1 to about 1.5.

In general, it is contemplated that any sized embodiment can be used. But, for example, said divertor plate can have a radius of about 0.2 m, 0.5 m, 1 m, 1.5 m, 2 m, 3 m, 4 m, 5 m, 6 m, 7 m, 8 m, 9 m, or about 10 m. In a further aspect, a divertor radius can be about 1.9 m, 3.3 m, 4 m, 7.3 m, or 7.5 m.

In one aspect, a divertor plate can have a divertor radius relative to an X point on a separatrix. As used herein, the term “separatrix” refers to the boundary between open and closed magnetic field lines, and an X point refers to a point on the separatrix where the poloidal magnetic field is zero. In one aspect, multiple X points exist in a disclosed embodiment, and main plasma X point refers to an X point adjacent to the said core plasma. For example, referring back to FIG. 1, the main X point is shown as 160. The radius of a main X point generally depends on the configuration of the magnetic field lines. In one aspect, a divertor plate can have a major radius that is greater than or equal to the radius of the main X point.

In one aspect, the ratio of the divertor plate radius to the X point radius, R_{div}/R_{X} can be from about 1 to about 5, or from about 1 to about 4, or from about 1 to about 3.5, or from about 1.5 to about 3.5. For example, a disclosed divertor plate and a disclosed separatrix can have radii as listed in Table 1, along with the corresponding ratio.

TABLE 1
Examples of R_{div} and R_{X}.

| R_{div} (m) | R_{X} (m) | R_{div}/R_{X} |
|---|---|---|
| 3.25 | 1.75 | 1.9 |
| 7.25 | 4.50 | 1.6 |
| 7.50 | 4.25 | 1.8 |
| 4.00 | 1.50 | 2.7 |
| 3.25 | 1.75 | 1.9 |
| 1.90 | 0.60 | 3.2 |
| 1.95 | 0.70 | 2.8 |
| 4.00 | 2.20 | 1.8 |

In yet a further aspect, a divertor plate can have a divertor radius relative to the major plasma radius, defined as the distance from said central axis to said plasma center. For example, the ratio of the divertor radius to the major plasma radius (R), R_{div}/R, can be from about 0.5 to about 10, or from about 1 to about 8, or from about 1 to about 6, or from about 1 to about 5, or from about 2 to about 5, including, for example, 0.5, 1, 2, 3, 4, 5, 6, 7, 8, 9, or 10. As a specific non-limiting example, if a plasma major radius is 1 m, and a divertor radius is 2 m, then R_{div}/R=2.

In one aspect, said divertor plate can be at least partially shielded from neutrons emitted from the core plasma. In a further aspect, said chamber walls at least partially shield the divertor plate from neutrons emitted from said core plasma, as shown, for example, in FIG. 1.

The neutron flux, defined as a measure of the intensity of neutron radiation in neutrons/cm²-sec. Neutron flux is the number of neutrons passing through 1 square centimeter of a given target in 1 second. Using embodiments of a divertor plate described herein, calculations show a decrease in neutron flux by a factor of over 10 as compared to other divertor plate designs.

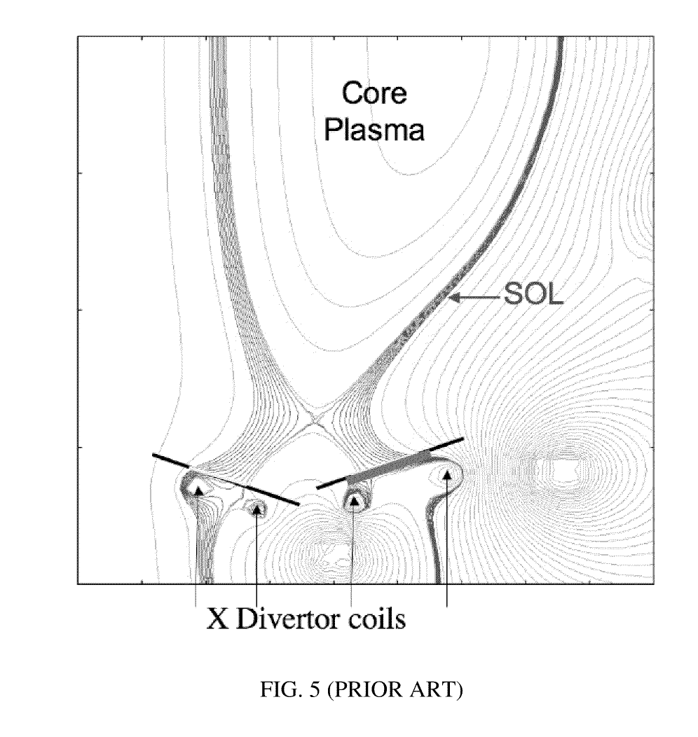

Additional divertor plates, not corresponding to the radii disclosed herein, can also be used in combination with a disclosed divertor plate. Specifically, known reactor designs can comprise divertor plates, wherein the divertor radius is less than the outer radius of a chamber, a plasma major radius, a separatrix, or another component or point within a vessel for containing fusion plasma. These known designs, in some aspects, can simply be augmented with an additional disclosed divertor design. Examples of such divertors include the standard divertor, as discussed herein, and the X divertor, as discussed in Kotschenreuther et al. “On heat loading, novel divertors, and fusion reactors,” Phys. Plasmas 14, 72502/1-25 (2006), which is hereby incorporated into this specification by reference in its entirety (hereinafter Kotschenreuther). An exemplary embodiment of an X divertor is shown in FIG. 5, wherein four poloidal field coils placed substantially adjacent to divertor plates expand the magnetic flux near the divertor plates so that the heat and plasma particle fluxes flowing from the core plasma into the SOL fall on larger areas of the divertor plates.

Referring to FIG. 1 and FIG. 2, in one aspect, a disclosed embodiment comprises a toroidal chamber 150 about a central axis 220. A major radius of any point around the central axis 220 denotes its perpendicular distance from the central axis 220. Directions perpendicular to the central axis 220 are radial, and directions in any plane containing the central axis 220 are poloidal. A toroidal core plasma 110 is substantially confined within the toroidal chamber 150 by magnetic field lines that stay substantially on closed toroidal magnetic surfaces 140. The closed magnetic surfaces 140 are created by electrical currents in the core plasma and by current-carrying conductors substantially adjacent to the toroidal chamber 150. The toroidal core plasma 110 is substantially enclosed by a region of open magnetic field lines 100 that intersect one or more divertor plates 130. A magnetic surface known as a separatrix separates the core plasma and the region of open magnetic filed lines and the separatrix intersects the divertor plates 130. Particles and energy that flow from the core plasma 110 across the separatrix into the region of open magnetic field lines are directed along the open magnetic field lines 100 to the divertor plates 130. Both, the closed magnetic surfaces 140 in the core plasma 110 and the open magnetic field lines 100 in the SOL are created by the current in the toroidal core plasma 110 and by the currents in conductors 120 substantially adjacent to the toroidal chamber 150. The core plasma 110 and the region of open magnetic field lines together are substantially enclosed by walls 150. An equatorial plane, which is perpendicular to the central axis 220, and which passes through a point at the largest major radius in the core plasma 110, divides the toroidal chamber 150 into upper and lower regions. When only the upper region is shown, as in FIG., the lower region is substantially a mirror image of the upper region in the equatorial plane. A major radius of any point is that point's perpendicular distance from the central axis. The major radii of points in the core plasma 110 that are farthest (or closest) from the central axis 220 are the outer plasma major radius (or inner plasma major radius). Half of the sum of the outer and inner plasma major radii is the plasma major radius, and half of the difference between the outer and inner plasma major radii is the plasma minor radius. A point in the upper (or the lower) region of the core plasma 110 farthest from the equatorial plane is the upper (or the lower) peak point. The largest major radius of points of intersection between the separatrix and the divertor plates 130 are the outboard divertor major radius and the corresponding divertor plate is the outboard divertor plate 130. A length along an open magnetic field line from a point approximately one-half centimeter outside the separatrix in the equatorial plane to the outboard divertor plate 130 is the SOL length, also known as the magnetic connection length.

A stagnation point or an X point is defined as any point where poloidal component of the magnetic field is zero. In one aspect, the separatrix contains at least one stagnation point whose perpendicular distance from the equatorial plane is greater than the plasma minor radius. In one aspect and for at least one divertor plate 130, the outboard divertor major radius is greater than or equal to the sum of the plasma minor radius and the major radius of the peak point closest to the corresponding divertor plate 130 In one aspect, this divertor plate 130 can be referred to as a Super-X Divertor or a Super X Divertor (SXD).

In one aspect, current-carrying conductors can generate and/or shape the magnetic field lines. The current-carrying conductors can be substantially adjacent to the toroidal chamber. In one aspect, the current-carrying conductor can comprise a material that maintains good mechanical properties under high total neutron dosages and can resist high neutron dose stresses for extended periods of time. In a further aspect, the current-carrying conductors can comprise aluminum or an alloy thereof.

Aluminum and alloys thereof generally have an acceptable tolerance for neutron damage. In one aspect, the current-carrying conductors comprised of aluminum or an alloy thereof can tolerate up to 200 dpa and still maintain good mechanical properties. In a further aspect, the aluminum or alloy thereof used in the current-carrying conductors can tolerate from 100 to 200 dpa and still maintain good mechanical properties.

The current-carrying conductors comprised of aluminum or an alloy thereof also generally absorb less neutrons than conventional current-carrying conductors. Thus, the aluminum or aluminum alloy conductors do not unnecessarily use neutrons (i.e., absorb) that would otherwise be useful in a disclosed process. Aluminum and aluminum alloys also have acceptable radioactivity after neutron exposure, which makes aluminum and aluminum alloys relatively safe materials for use in a disclosed device or process.

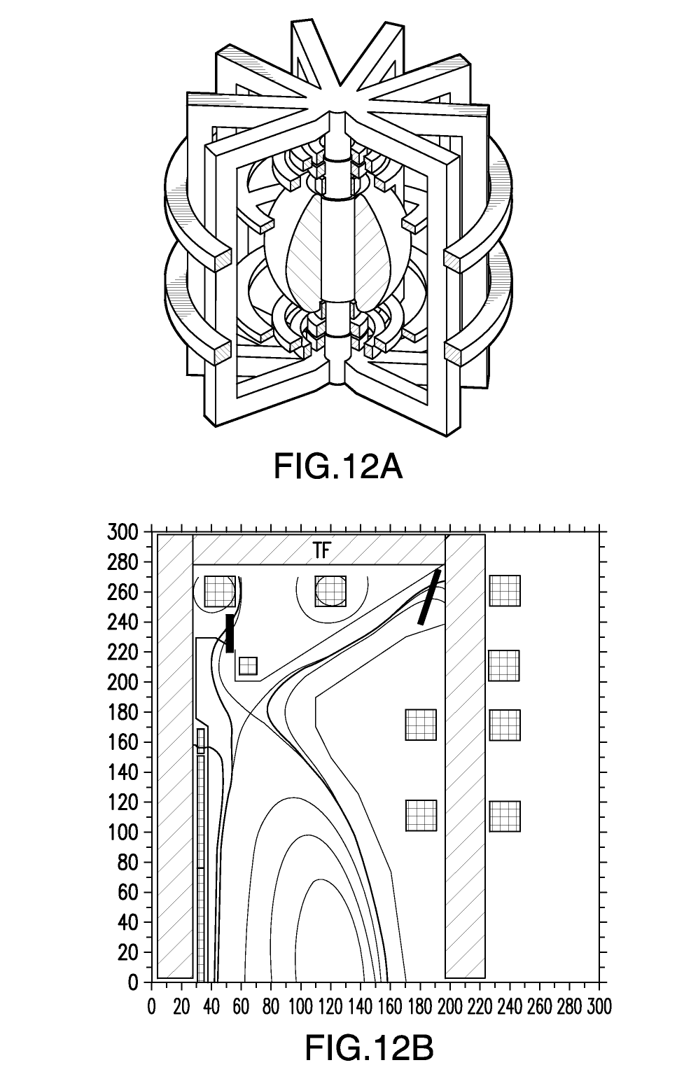

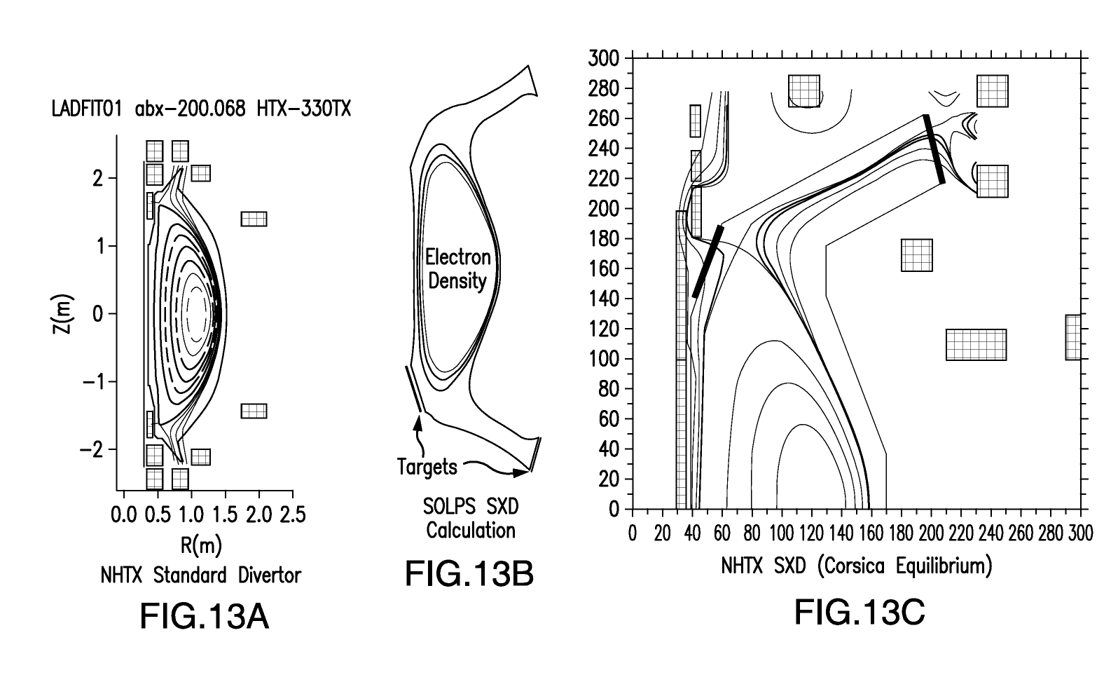

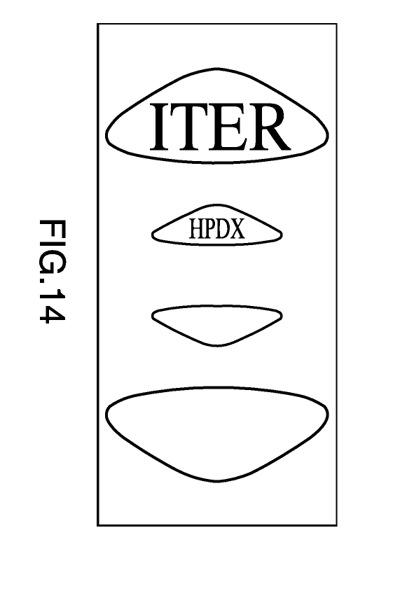

Generally, the toroidal field current-carrying conductors can comprise different sections of coils. Each section can comprise different materials. For example, certain sections can comprise aluminum or an alloy thereof, while other sections can comprise another conductor, such as copper. In one aspect, the toroidal field current-carrying conductors can comprise at least 20% by volume aluminum, wherein volume refers to the total volume of the toroidal field current-carrying conductors. For example, with reference to FIG. 12B, toroidal conductors are shown as the grey shaded portion surrounding the toroidal chamber. A portion, or all, of these toroidal conductors can comprise aluminum or an alloy thereof. For example, one or more of the vertically elongated toroidal field coils shown in FIG. 12B can comprise aluminum, while the horizontally elongated toroidal field coil (top or bottom coil) can comprise another material or alloy, such as copper.

The current-carrying conductors or sections of the current-carrying conductors can comprise up to 100% aluminum by volume, wherein volume in this instance refers to the current-carrying conductor or section of the current-carrying conductor that comprises aluminum (i.e., not necessarily the total current-carrying conductor volume). In one aspect, the current-carrying conductor or section thereof preferably comprises at least 80% aluminum by volume, for example, 80%, 85%, 90%, or 95% aluminum. When the current-carrying conductor comprises an aluminum alloy, any other appropriate alloy constituent can be used. In one aspect, the aluminum alloy comprises aluminum and one or more of copper, zinc, magnesium, silicon, or manganese. In a further aspect, the aluminum alloy comprises aluminum and copper, for example, an aluminum-copper alloy comprising at least 20% aluminum. In another aspect, the aluminum-copper alloy comprises at least 50% aluminum.

In one aspect, current-carrying conductors or coils substantially adjacent to the toroidal chamber create a magnetic flux expansion (i.e., spread magnetic surfaces or decrease the poloidal component of the magnetic field) in the region of open magnetic field lines that intersect one or more divertor plates. Therefore, energy and particles transferred to the divertor plate 130 can be distributed over an expanded area of the divertor plate 130, thus decreasing the average and peak fluxes of energy and particles incident on the divertor plate 130, and the magnetic connection length can be optionally increased. In one aspect, the magnetic connection length is greater than twice the magnetic connection length for an instance in which the divertor plate is located at the corresponding stagnation point and in a plane perpendicular to the central axis. In a further aspect, the magnetic connection length to the divertor plate is long enough so that electrons coming from the core plasma cool to a temperature of less than about 40 electron volts (eV) of energy before reaching said divertor plate.

In yet a further aspect, low plasma temperature near the divertor plate 130 allows an increase in radiation of energy from the plasma near the divertor plate 130. In a still further aspect, the magnetic connection length to the divertor plate 130 are long enough to maintain a detached plasma, i.e., maintain a stable zone of plasma at a temperature less than about 5 eV between the divertor plate 130 and the plasma.

In one aspect, the pumping ability (i.e., the pumping of helium ash from fusion reactions) can be enhanced by embodiments of the divertor plate as described herein because the major radius of the divertor plate is larger than the major radius of the nearest peak point by an amount grater than the plasma major radius. While not wishing to be bound by theory, this enhancement can result in a) an increase in the neutral pressure near the divertor plate, b) decreased pumping channel lengths from the divertor to pumps, and/or c) increased maximum area of the pumping ducts due to the larger major radius of a disclosed divertor.

Because of the larger major radius of embodiments of the divertor plates as described herein, a liquid metal such as, for example, lithium, can be present or flowing on a disclosed divertor, and can, in some aspect, be used efficiently on the divertor plates because the lower magnetic field at the larger major radius reduces the magnetohydrodynamic effects on the liquid metal.

In one aspect, the purity of the core plasma can be increased by embodiments of the divertor plate described herein. Without wishing to be bound by theory, this can result from a) a reduction in sputtering from the divertor plate due to lower plasma temperature, b) an increase in plasma density near the plate that can reduce the amount of sputtered material reaching the core plasma, and/or c) the increased length of a disclosed divertor as compared to standard divertors, which results in any sputtering occurring further from the core plasma and sputtering at the divertor plate can be shielded from the core plasma by the walls of the toroidal chamber or the longer SOL distance between the divertor plate and the core plasma.

It should be appreciated that in a further aspect, a longer magnetic connection length can enable one or more of the following improvements as compared to devices with standard divertors: a) allowing lower plasma temperature near the divertor plates, b) allowing higher plasma and neutral densities near the divertor plates, c) enhanced spreading of heat by either plasma-generated or externally driven turbulence in the SOL, without also significantly increasing the turbulence in the core plasma, and/or d) sweeping the regions of highest heat or particle flux on the SXD plates at a rate fast enough so that the resulting spatial and temporal redistribution of the heat flux reduces the peak temperature of the divertor plate.

In one aspect, the use of embodiments of the divertor plate described herein allows power density in the core plasma to be substantially higher than known toroidal plasma devices. In a further aspect, the fusion power density in the core plasma is substantially higher than known toroidal plasma devices. For example, if power density is defined as the quotient of the core heating power in megawatts and the plasma major radius (described in more detail herein) in meters, then embodiments described herein can produce a power density of about five megawatts per meter or greater. Of course, lower power densities are also contemplated within the scope of the described embodiments. This high power density can result in a core plasma of sufficient heat and density to produce a large number of neutrons from fusion reactions of plasma particles.

It will be apparent that the various disclosed radii for components within a disclosed embodiment can be determined by a physical measurement of a working embodiment. Or, in the alternative, a disclosed radius can be determined through a model, such as, for example, a model generated by CORSICA™. Thus, in one aspect, a physical embodiment can be deduced to a model, and the various parameters can be determined by the model.

In one aspect, a disclosed embodiment comprises plasma or fusion plasma that is substantially magnetically contained within a vessel for containing the plasma, a fusion neutron source, or a tokamak, by closed magnetic surfaces and open magnetic field lines relative to the fusion plasma. A disclosed core plasma can have a major radius and a minor radius. The major radius of the plasma can be the radius of the plasma as a whole (from the central axis to the center of the plasma). The minor radius can be the radius of the plasma itself, i.e., average distance extending from the center of the plasma to the perimeter of said plasma.

The fuel to be used as plasma can, at least in principle, comprise combinations of most of the nuclear isotopes near the lower end of the periodic table. Examples of such include, without limitation, boron, lithium, helium, and hydrogen, and isotopes thereof (e.g., ²H, or deuterium). Non-limiting reactions of deuterium and helium, for example that can occur within nuclear fusion plasma are listed below.

D+D→p+T (tritium)+˜3 MeV, wherein p is a proton;

D+D→n+³He+˜4 MeV, wherein n is a neutron;

D+T→n+⁴He+˜17 MeV;

D+³He→p+⁴He+˜18 MeV;

Any known means of heating a fuel to create said fusion plasma, and heating said fusion plasma to the temperatures required for fusion to occur can be used in combination with the disclosed embodiments, including the disclosed methods. Plasmas can be generated in various ways including DC discharge, radio frequency (RF) discharge, microwave discharge, laser discharge, or combinations thereof, among others. Plasmas can be generated and heated, for example, by ohmic heating, wherein plasma is heated by passing an electrical current thought it. Another example is magnetic compression, whereby the plasma is either heated adiabatically by compressing it though an increase in the strength of the confining field, or it is shock heated by a rapidly rising magnetic field, or a combination thereof. Yet another example is neutral beam heating, wherein intense beams of energetic neutral atoms can be focused and directed at the plasma from neutral beam sources located outside the confinement region. Yet another example is radio frequency heating, wherein intense radio waves launched from antennas or waveguides are absorbed in the plasma to produce plasma heating.

Combinations of the aforementioned heating protocols can be used, as well other methods of heating. For example, neutral beam heating can be used to augment ohmic heating in a magnetic confinement device, such as a tokamak. Other methods of heating include, without limitation, heating by RF, microwave, and laser.

Any appropriately shaped plasma of any size compatible with a disclosed embodiment can be used. A discussion of plasma shapes can be found in “ITER,” special issue of Nucl. Fusion 47 (2007), which is hereby incorporated by reference into this specification in its entirety. The shape of fusion plasma, in one aspect, can determine the desire of a particular shape of a vessel for containing said fusion plasma.

Various factors can determine a desired plasma size, one of which is the containment time, which is Δt=r²/D, wherein r is a minimum plasma dimension and D is a diffusion coefficient. The classical value of the diffusion coefficient is D_{c}=αᵢ²/τᵢₑ, wherein αᵢ is the ion gyroradius and τᵢₑ is the ion-electron collision time. Diffusion according to the classical diffusion coefficient is called classical transport.

The Bohm diffusion coefficient, attributed to short-wavelength instabilities, is D_{B}=( 1/16)αᵢ²Ωᵢ wherein Ωᵢ is the ion gyrofrequency. Diffusion according to this relationship is called anomalous transport. The Bohm diffusion coefficient for plasma, in some aspects, can determine how large plasma can be in a fusion reactors, vis-à-vis a desire that the containment time for a given amount of plasma be longer than the time for the plasma to have nuclear fusion reactions. On the contrary, reactor designs have been proffered wherein a classical transport phenomenon is, at least in theory, possible. Thus, in one aspect, one or more disclosed embodiments can be compatible with plasma comprising anomalous transport and/or classical transport.

During magnetic confinement of plasma, ionized particles can be constrained to remain within a defined region by specifically shaped magnetic fields. Such a confinement can be thought of as a nonmaterial furnace liner that can insulate hot plasma from the chamber walls.

In one embodiment, a magnetic field can be created to form a torus or a doughnut-shaped figure within which magnetic field lines form nested closed surfaces. Thus, in this geometry, plasma particles are permitted to stray only by crossing magnetic surfaces. In theory, this diffusion is a very slow process, the time for which has been predicted to vary as the square of the plasma minor radius, although much faster cross-diffusion patterns have been observed in experiment.

To direct anomalous and/or classical cross-magnetic field particle transport away from the plasma, particles from the fusion plasma that cross said separatrix can be directed to a plasma-wetted area on said divertor plate by said open magnetic field lines in said scrape off layer outside said separatrix.

In a further aspect, a disclosed embodiment can provide at least one divertor plate wherein the plasma-wetted area, A_{w}, on at least one divertor plate is increased beyond currently known fusion neutron source designs. Without wishing to be bound by theory, in an embodiment comprising one or more divertor plates, A_{w} on the divertor plate can be bound via the equation Divergence of B=0, to be

$${A}_{w} = \frac{{B}_{p , sol}}{{B}_{div}} \frac{{A}_{sol}}{sin ( θ )} \approx {[ \frac{{B}_{p}}{{B}_{t}} ]}_{sol} \frac{{R}_{div}}{{R}_{sol}} \frac{{A}_{sol}}{sin ( θ )} ,$$

wherein Rₛₒₗ, Wₛₒₗ, and Aₛₒₗ=2πRₛₒₗWₛₒₗ are the radius, width, and area of the scrape-off layer (SOL) at the (outer or inner) midplane for the corresponding divertor plates, wherein θ is the angle between the divertor plate and the total magnetic field, B_{div}, and the subscripts p(t) denote the poloidal (toroidal) directions. For a given Wₛₒₗ and Bₚ/Bₜ at the midplane, A_{w} can be increased, in one aspect, by reducing θ. However, it is apparent that engineering constraints can, in some aspects, place a limit of about 1 degree on the minimum θ, as determined, for example, in the ITER design, outlined in “ITER,” special issue of Nucl. Fusion 47 (2007), which is hereby incorporated by reference into this specification in its entirety. However, some disclosed designs comprise a divertor plate with a θ of less than about 1 degree (e.g.,)0.9°).

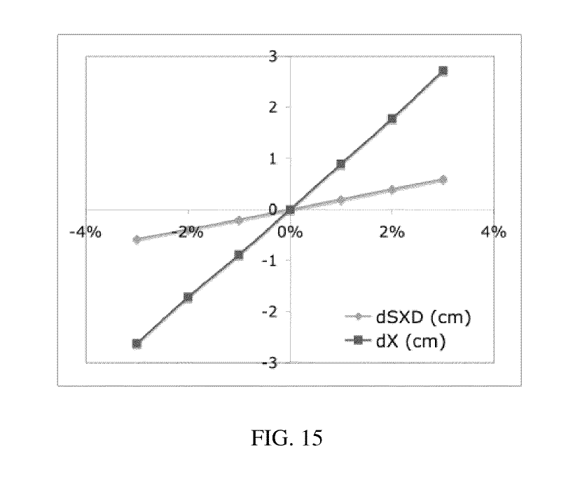

In one aspect, a disclosed embodiment can comprise an increase in R_{div}, the divertor radius (with respect to the central axis) to affect an increase in A_{w}. It should be appreciated that increasing R_{div}, in one aspect, increases the distance between the divertor plate and the current in the plasma, which can make the divertor less sensitive than a standard divertor to plasma fluctuations. For example, as shown in FIG. 15, by changing the plasma pressure (or current) by ±5% (while holding coil currents and flux through the wall fixed to simulate sudden changes), this moves the outer strike points on the disclosed divertor plate by only about ±0.05 cm (see curve labeled dSXD in FIG. 15) which is much smaller than about ±2.5 cm motion produced in a standard divertor (see curve labeled dX in FIG. 15), Such small motions are small fractions of the widths of an exemplary plasma-wetted area (about 20 cm).

In one aspect, particles from said fusion plasma can travel a magnetic distance along open magnetic field lines from the fusion plasma to the divertor plate that is greater than a radial distance from the fusion plasma to the divertor plate. In a further aspect, the particles cool while traveling the magnetic distance along the open magnetic field lines to the divertor plate.

It is apparent that an increase in R_{div}/Rₛₒₗ can increase the magnetic connection length, L, of a scrape off flux particle by increasing the poloidal field all along the divertor leg at R. In one aspect, an extended L can increase the maximum allowed power (Pₛₒₗ) in the scrape-off layer (SOL). The maximum divertor radiation fraction and the cross-field diffusion can both be enhanced. The longer L in a disclosed divertor can restore the capacity for substantial radiation even at high qₗₗ (heat transferred per unit mass), increasing Pₛₒₗ relative to a standard divertor by a factor of about 2. The longer line lengths can lower the plasma temperature at the plate at relevant high upstream qₗₗ. These results can be obtained, for example, by 1D-code, using CORSICA™, for example, as described in Kotschenreuther. As the plasma particles flow to the divertor along the extended field lines, cross-field diffusion effectively widens the SOL, resulting in a larger plasma footprint on the divertor plate. In one aspect, for example, an increase in SOL width by about 1.7 relative to a standard divertor can be expected.

A disclosed embodiment can provide for improvements in the capability of a fusion neutron source, vessel for containing fusion plasma, or tokamak to manage the problem of heat exhaust. The heat exhaust that occurs during the operation of a nuclear fusion reactor can be related to the heating power, Pₕ=auxiliary heating power, Pₘₐₓ plus about 20% of the fusion power, P_{f}. For example, two of largest current tokamaks, the joint European torus (JET) in the European Union, with a major radius R=3 m, and the JT-60 tokamak in Japan, with R=3.4 m, each have a Pₕ=120 MW, which is less than the P_{f} of about 400-500 MW. ITER (France), a joint international research and development project that aims to demonstrate the scientific and technical feasibility of fusion power, by contrast, is designed for a Pₕ˜400-720 MW, with P_{f}˜2000-3600 MW. A measure of the severity of the heat flux problem can be estimated, in some aspects, as Pₕ/R, wherein R is the plasma major radius.

Kotschenreuther et al. in “On heat loading, novel divertors, and fusion reactors,” Phys. Plasmas 14, 72502/1-25 (2006), which is hereby incorporated by reference in its entirety, discusses the severity of the heat flux problem in detail. Specific reference is made to Table 1 of Kotschenreuther and the discussion of the data presented therein, as it applies to the present context, wherein various Pₕ/R values for known reactors, including future reactors, are listed.

In one aspect, a disclosed embodiment can be a tokamak. As used herein, the term “tokamak” refers to a magnetic device for confining plasma. While tokamaks generally comprise a toroidal shaped magnetic field which is substantially axisymmetric, i.e., approximately invariant under toroidal rotations about a central axis, a “tokamak,” as disclosed herein, is not limited to an axisymmetric toroidal shape. Other toroidal designs and shapes, both known and unknown, will likely be compatible with the various embodiments disclosed herein. Known toroidal alternatives to the traditional tokamak reactor are stellarators, spherical toroids (i.e., a cored apple shaped tokamak), reverse-field pinch reactors, and spheromaks.

It should be appreciated that, in various embodiments, the geometrical configurations of the divertor plate as described herein can be accommodated by most, if not all, known tokamak designs, including predicted future tokamak designs. As an example, a divertor plate can fit inside toroidal field coils in corners or sections that often go unused, and any toroidal field ripple (unwanted curving of magnetic field lines) arising at the divertor plates can be handled by slight shaping of the divertor plates.

In one aspect, a disclosed embodiment can be a tokamak-based High Power Density (HPD) Device. High power density of a disclosed device can be attained, for example, by reducing the size of the device, thereby increasing the power density. In one aspect, a disclosed high power density embodiment can have a major radius R of from about 1 m to about 5 m, or from about 1 m to about 4 m, or from about 1 m to about 3 m. Parameters for an exemplary high power density device are listed in Table 2. With reference to Table 1, an exemplary device can have a major radius of about 2.2 m, with an aspect ratio of about 2.5, wherein the aspect ratio is defined as the major/minor dimensions of the plasma torus at the horizontal equatorial plane (plasma major radius/plasma minor radius=aspect ratio).

Angular brackets such as < > denote average value of a parameter averaged over the core plasma volume. For example, <n> denotes the average density of particles in the core plasma.

Elongation of the plasma confined in a disclosed embodiment of a tokamak based High Power Density (HPD) Device can be from about 1.5 to about 4, or from about 2 to about 3. Elongation measures the vertical height of the plasma minor cross section compared to the horizontal minor cross section. This parameter is typically measured at the separatrix (i.e., the magnetic surface dividing the closed plasma nested flux surfaces from the open ones that intersect the material walls) as well as at 95% of the flux at the separatrix, which gives a good measure of the useful part of the plasma. With reference to Table 1, an exemplary high power density device can have an elongation of about 2.4 to about 2.7.

A disclosed embodiment of a Tokamak based High Power Density (HPD) Device can have a total toroidal plasma current (Iₚ) of from about 10 to about 20 MA, or from about 10 to about 15 MA. It will be apparent that Iₚ can change during the operation of an embodiment. With reference to Table 2, for example, Iₚ for an exemplary embodiment can be from about 12 to about 14 MA. A disclosed HPD device can have a self-generated plasma current (bootstrap current) fraction of about 30 to about 90%, or from about 30 to about 80%. An exemplary device, for example, can have a bootstrap current fraction of from about 40 to about 70% (Table 2). The current drive power in such a device, can be, for example, from about 20 to about 90 MW (e.g., from about 25 to about 60 MW, see Table 2). Although not wishing to be bound by theory, in one aspect, additional power for D-D fusion and/or Ion Cyclotron Resonance Heating (ICRH) can be from about 20 to about 50 MW. For example, power for these processes can be about 40 MW (Table 2).

If a Cu coil (e.g., a coil with about 60% Cu) is used for an HPD device, coil related dissipation can be about 160 MW for an exemplary device. The CD electric input to provide power to these coils can be, for example, from about 50 to about 120 MW. It is thought that the magnetic field at an exemplary Cu coil would be about 7 T (Table 2).

The Iₚ and other induced currents, if present, can create a magnetic field at the plasma center, B_{T}, of from about 2 T (Tesla) to about 10 T, or from about 2 T to about 5 T. For example, a disclosed HPD device can have a magnetic flux density at the plasma center of about 4.2 T (Table 2). The volume averaged temperature <T>can be from about 10 to about 20 keV (kilo electron Volts), or from about 10 to about 18 keV. For example, an HPD device can have a volume averaged temperature <T> of about 15 keV (Table 2).

The normalized β(β_{N}) in a disclosed HPD device can be from about 2 to about 8, or from about 2 to about 5. An exemplary device, as listed in Table, can have a β_{N} of about 3-4.5. Normalized β(β_{N}), as used herein, is the ratio of plasma beta to a˜B/I (a=minor radius, B=toroidal magnetic field on central axis, and I=plasma current). Plasma beta is the ratio of plasma pressure (the sum of the product of density and temperature over all the plasma particles) divided by the magnetic pressure (B²/2μ₀)—a volume-integrated parameter which measures how good the magnetic field is at confining the plasma, and is typically a few % (percent).

Peaking value of a parameter is the ratio of its maximum value to its volume averaged value in the core plasma.

A disclosed HPD device can have a fusion power of up to 500 MW, or from about 0 MW to about 500 MW. An exemplary device, as listed in Table 2, can have a fusion power of up to about 400 MW, or from about 0 MW to about 400 MW. Fusion power, as used herein, is the total power generated by the fusion reactions in the plasma (i.e., not taking account of any energy multiplication that can take place by reactions in the surrounding structure). Other power parameters include Alpha-particle power, which is the part of the fusion power carried by the fused nuclei. Alpha power plus external heating power minus radiated power is the net heating power to the plasma. For a plasma generating a fusion power of up to 500 MW, an exemplary device can have a neutron wall load of from about 2 to about 3 MW/m² (Table 2). Impurities in the plasma, depending on the composition, can, in one aspect, comprise He (e.g., 10% He) and/or Ar (e.g., 0.25% Ar).

With reference to Table 2, a disclosed HPD device can have a H_{89P}, wherein H_{89P} is the energy confinement improvement factor compared with the ITER89-P, of from about 2.6 to about 2 (for DIII-D reactions). It will be apparent that such a device can have a Q value, defined as the fusion power divided by input power of about 0.1 to about 1.9.

TABLE 2
Parameters for Exemplary High Power Density Device.

| R major | 2.2 | |
|---|---|---|
| Aspect ratio | 2.5 | |
| Elongation | 2.4-2.7 | |
| Iₚ | 12-14 | MA |
| B_{T} (plasma center) | 4.2 | T |
| <n> | 1.6 × 10²⁰ | |
| <T> | 15 | kev |
| β_{N} | 3-4.5 | (DIII-D) |
| Peaking p(0)/<p>, n(0)/<n> | 2-2.5, 0-1.6 | |
| Fusion Power | Up to 400 MW | |
| Bootstrap fraction | 40%-70% | (DIII-D) |
| Current Drive power | 25-60 | MW |
| Oilier power for DD (ICRH?) | 40 | MW |
| H_{89P} factor | 2.6-2 | (DIII-D) |
| CD η (scaled from reactor | .15 | |
| studies as n/R) | | |
| Impurities | 10% He .25% Ar | |
| Fusion Power | 300-400 | MW |
| Coil related dissipation | 160 | MW |
| CD electric input | 50-120 | MW |
| B_{T} at Copper TF coil | 7 | T |
| Cu fraction in coil | 60% | |
| Current Drive wall plug- | 50% | |
| plasma efficiency | | |
| Neutron Wall load | 2-3 | MW/m² |

| | |
|---|---|
| Q_{XT} | 1.-1.9 |

It is understood that the disclosed devices can be used in combination with the disclosed components (e.g., divertor plates, etc.), methods, devices, and systems.

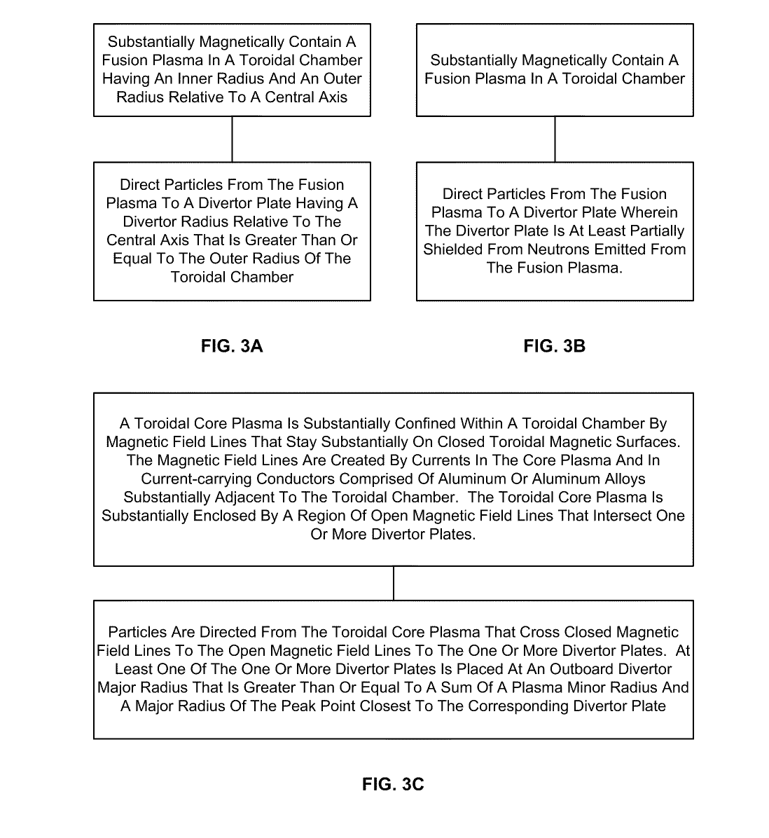

Also disclosed are methods of exhausting heat from disclosed embodiments. In one aspect, as shown in the partial flowchart of FIG. 3A, a method of exhausting heat from a fusion neutron source comprises the steps of: creating a toroidal core plasma in a toroidal chamber about a central axis, wherein the toroidal core plasma is substantially confined within the toroidal chamber by magnetic field lines that stay substantially on closed toroidal magnetic surfaces, said closed magnetic field lines created by currents in the core plasma and in current-carrying conductors substantially adjacent to said toroidal chamber, and said toroidal core plasma is substantially enclosed by a region of open magnetic field lines that direct particles from the fusion plasma that cross said closed magnetic field lines to said open magnetic field lines to a divertor plate having a divertor radius relative to the central axis that is greater than or equal to the outer radius of the toroidal chamber, said particles directed to said divertor plate by said open magnetic field lines. Another aspect of exhausting heat from a fusion neutron source as shown in the exemplary partial flowchart of FIG. 3B comprises the steps of: creating a toroidal core plasma in a toroidal chamber about a central axis, wherein the toroidal core plasma is substantially confined within the toroidal chamber by magnetic field lines that stay substantially on closed toroidal magnetic surfaces, said closed magnetic field lines created by currents in the core plasma and in current-carrying conductors substantially adjacent to said toroidal chamber, and said toroidal core plasma is substantially enclosed by a region of open magnetic field lines that intersect one or more divertor plates; and directing particles from the toroidal core plasma that cross said closed magnetic field lines to said open magnetic field lines to the one or more divertor plates, wherein the divertor plate is at least partially shielded from neutrons emitted from the fusion plasma. Another method of exhausting heat and particles from a toroidal plasma device is described in FIG. 3C. In this process, a toroidal core plasma is created in a toroidal chamber about a central axis. The toroidal core plasma is substantially confined within the toroidal chamber by magnetic field lines that stay substantially on closed toroidal magnetic surfaces. The magnetic field lines are created by currents in the core plasma and in current-carrying conductors comprised of aluminum or aluminum alloys substantially adjacent to the toroidal chamber. The toroidal core plasma is substantially enclosed by a region of open magnetic field lines that intersect one or more divertor plates. Particles are directed from the toroidal core plasma that cross the closed magnetic field lines to the open magnetic field lines to the one or more divertor plates. At least one of the one or more divertor plates is placed at an outboard divertor major radius that is greater than or equal to a sum of a plasma minor radius and a major radius of the peak point closest to the corresponding divertor plate.

In one aspect, fusion plasma can be created by methods known in the art, as discussed herein. Current can be driven in said fusion plasma by known methods to help contain the plasma. Furthermore, current-carrying conductors or coils can be strategically placed to create magnetic fields that help contain, form, control, and/or shape said fusion plasma, including open magnetic field lines for routing particles from the fusion plasma to the divertor plate, as discussed herein.

It is understood that the disclosed methods can be used in combination with any aspect of any disclosed embodiment, including vessels for containing plasma, fusion neutron sources, and tokamaks. Thus, for example, a method of exhausting heat comprising a disclosed step can be applied to a vessel for containing fusion plasma, a fusion neutron source, or a tokamak.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Modified Design of Steady State Superconducting Tokamak

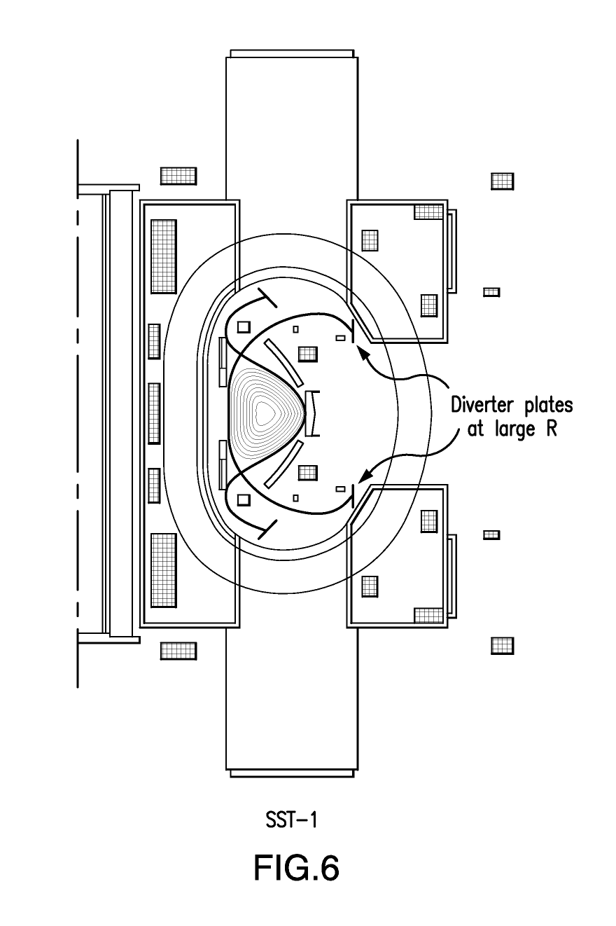

FIG. 6, modified from FIG. 1 in Bora et al., Brazilian Journal of Physics Vol. 32, no. 1, pg. 193-216, March 2002, the contents of which are incorporated herein by reference, displays an exemplary modified design of a Steady State Superconduction Tokamak (SST). Various parameters for the SST embodiment are listed in Table 3. An SST device can comprise a toroidal chamber, wherein at least a portion of the toroidal chamber comprises graphited-bolted tiles. Stabilizer materials can also be used with such a device and can comprise, for example, a Cu alloy (e.g., a Cu—Zr alloy). An exemplary SST design can have a plasma major radius, R, defined as the distance from the central axis to the center of the plasma, of about 1.1 m, and a plasma minor radius, a, defined as the distance from the center of the plasma to the perimeter of the plasma where the plasma is thickest, of about 0.2 m. The plasma current, Iₚ, as defined hereinabove, can be about 220 kA, with a Toroidal Field begin defined by a magnetic field at the plasma center, B_{T}, of about 3 Tesla.

The plasma for such an SST design can have an elongation of ≦ about 1.9, and a triangularity of ≦ about 0.8, wherein triangularity refers to a measure of the degree of distortion towards a D-shaped plasma minor cross section from an elliptic shaped plasma cross section. A fuel for a plasma confined within an SST device can, for example, comprise hydrogen gas. The plasma can be created and/or heated by ohmic heating, discussed hereinabove. Additional current that can be used during the course of an operation of an SST device include LHCD, or Lower Hybrid Current Drive, which can be current originating from quasi-static electric waves propagated in magnetically confined plasmas. The ohmic heating plus the LHCD can be, for example, 1 MW at 3.7 GHz. Ion Cyclotron Resonance Heating (ICRH) and Neutral Beam Injection Heating (NBI) can each be about 1 MW, wherein the sum of each is about 2 MW.

An exemplary SST device can have a divertor configuration as defined herein, wherein the divertor plate is positioned relative to a component or aspect of a device. A divertor configuration can be a double null (DN configuration). Such a divertor system can be compatible, for example, with an average heat load of about 0.5 MW/m², with a peak heat load of about 1 MW/m².

For a pulsed experiment, a discharge duration (i.e., the amount of time external current is applied to the device per pulse) can be, for example, about 1000 seconds.

TABLE 3
Parameters for modified SST design.

| Major Radius, R | 1.1 | m |
|---|---|---|
| Minor Radius, a | 0.2 | m |
| Plasma Current Iₚ | 220 | kA |
| Toroidal Field, B_{T} | 3 | Tesla |
| Elongation | ≦1.9 | |
| Triangularity | ≦0.8 | |
| Discharge duration | 1000 | seconds |

| | |
|---|---|
| Fuel Gas | Hydrogen |
| Divertor Configuration | DN |
| Divertor Heat Load | 0.5 MW/m² (average); 1 MW/m² (peak) |
| First Wall Material | Graphited-bolted tiles |
| Stabilizer Material | Cu—Zr alloy |
| Number of SC TF Coils | 16 |
| Number of SC PF Coils | 9 |
| Number of SC PF Coils | 6 |
| Current Drive | Ohmic + LHCD (1 MW @ 3.7 GHz) |
| Heating | ICRH(1 MW) NBI (1 MW) = 2 MW |

2. Divertor Designs Comprising Extended Single and Split Divertor Coils

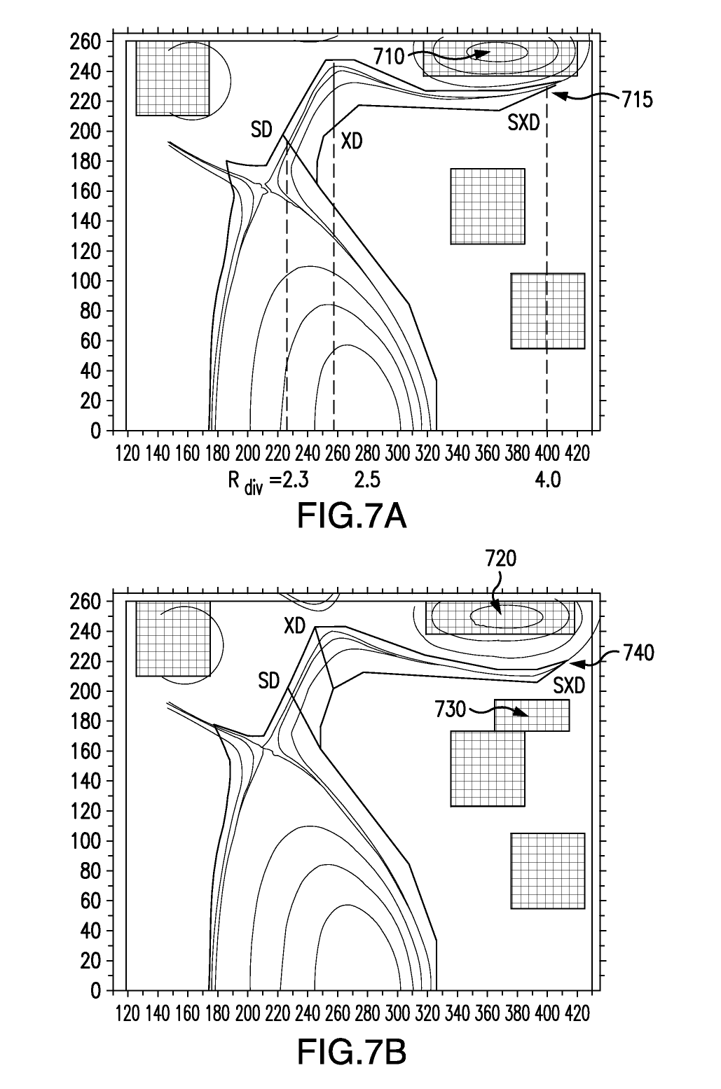

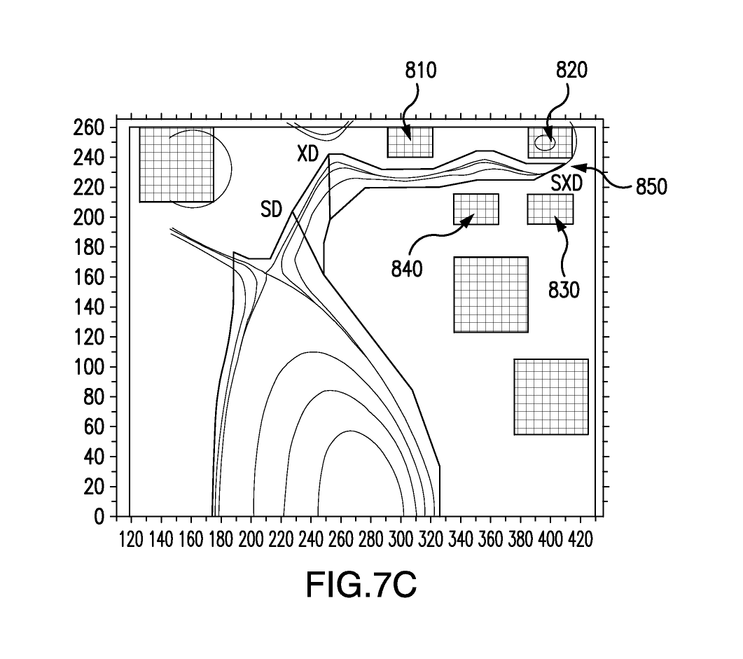

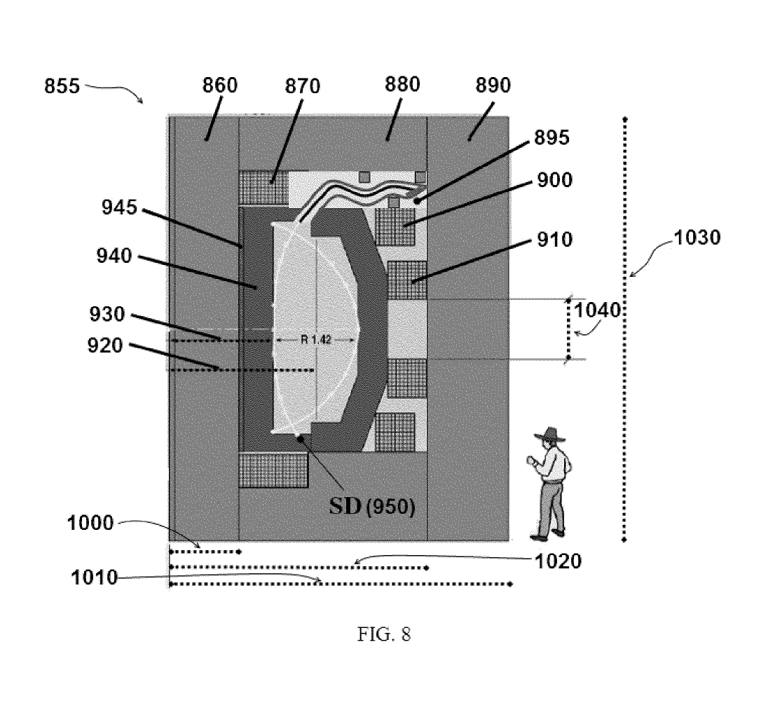

CORSICA™ equilibrium for an exemplary design, are shown in FIG. 7A. With reference to FIG. 7A, an exemplary design can comprise, in addition to PF coils needed to create a standard divertor configuration, one extra poloidal field (PF) coil or current-carrying conductor 710 which can be placed in a toroidal field (TF) corner, i.e., in a section near the toroidal field coils wherein neutron flux is substantially lower than a non-shielded section of the device.

Various parameters for this device are listed in Table 4. The listed B Angle in Table 4 is the angle between the divertor plate 715 and the total magnetic field, B_{div}. The B Length, is the magnetic connection length, or the magnetic line length, as discussed hereinabove. R_{div} is the divertor radius. Max area is the plasma wetted area on the divertor plate, as discussed hereinabove. The volume averaged temperature is represented by T in units of eV. The values for T listed in Table for are in reference to peak operation volume average temperatures. The results from Scrape-off layer plasma simulation calculations (SOLPS) are also presented.

With reference to Table 4 and FIG. 7A, various parameters for this embodiment are as follows: R_{div}=4.01 m, 1° Wet Area=5.6 m², B Length=61.8 m, B Length gain=4.0, MA-m ratio=1.62. As shown in FIG. 7A, both the standard divertor (SD) (R_{div}=2.3 m) and the X divertor (XD) (R_{div}=2.5 m) (see Kotschenreuther) have a smaller R_{div} than the disclosed divertor plate 715 (SXD). For comparative examples, Table 4 lists various parameters for the three aforementioned divertor designs, including a presently disclosed design.

TABLE 4
Parameters for standard divertor (SD), X divertor (XD), and an
embodiment of a disclosed divertor (SXD) for a reactor design.

| Div | B Angle | B Length | R_{div} | Max Area | T eV | SOLPS |
|---|---|---|---|---|---|---|
| Plate | Degrees | [m] | [m] | m² (at 1°) | at Peak | MW/m² |
| SD | 1.28 | 27.4 | 2.34 | 3.27 | 150 | 58 |
| XD | 0.93 | 39.7 | 2.51 | 3.51 | 150 | 28 |
| SXD | 1.2 | 61.6 | 4.01 | 5.61 | 10 | 18 |

For 5 mm wSOL at z = 0

CORSICA™ equilibrium for yet another exemplary design are shown in FIG. 7B, wherein a design comprises, in addition to PF coils needed to create a standard divertor configuration, two additional PF coils 720 and 730 (i.e., wherein 1 coil is split into 2 coils). In this example, more flux expansion and greater line length can be achieved by splitting a single divertor coil into two separate divertor coils.

Various parameters for this device are listed in Table 5. The listed B Angle in Table 5 is the angle between the divertor plate 740 and the total magnetic field, B_{div}. The B Length, is the magnetic distance, or the magnetic line length, as discussed hereinabove. R_{div} is the divertor radius. Max area is the plasma wetted area on the divertor plate, as discussed hereinabove. The volume averaged temperature is represented by T in units of eV. The values for T listed in Table for are in reference to peak operation volume average temperatures. The results from Scrape-off layer plasma simulation calculations (SOLPS) are also presented.

With reference to Table 5 and FIG. 7B, the parameters for this design are as follows: R_{div}=4.04 m 740, 1° Wet area=5.73 m², B Length=66.6 m, B Length gain=4.24, MA-m ratio=1.89. Table 5 show parameters for this exemplary split design, in comparison with a standard divertor (SD) and an X divertor (XD) (see Kotschenreuther).

TABLE 5
Parameters for standard divertor (SD), X divertor (XD), and an
embodiment of a disclosed divertor 740 (SXD) for a reactor design.

| Div | B Angle | B Length | R_{div} | Max Area | T eV at | SOLPS |
|---|---|---|---|---|---|---|
| Plate | Degrees | [m] | [m] | m² (at 1°) | Peak | MW/m² |
| SD | 1.14 | 28.0 | 2.33 | 3.30 | 150 | 58 |
| XD | 1.07 | 42.0 | 2.51 | 3.56 | 150 | 28 |
| SXD | 1.00 | 66.6 | 4.04 | 5.73 | <8 | <18 |

For 5 mm wSOL at z = 0

CORSICA™ equilibrium for another exemplary design are shown in FIG. 7C, wherein, in addition to PF coils needed to create a standard divertor configuration, there are four extra PF coils 810, 820, 830, and 840 (i.e., wherein one coil is split into four coils).

Various parameters for this device are listed in Table 4. The listed B Angle in Table 4 is the angle between the divertor plate 850 and the total magnetic field, B_{div}. The B Length, is the magnetic distance, or the magnetic line length, as discussed hereinabove. R_{div} is the divertor radius. Max area is the plasma wetted area on the divertor plate, as discussed hereinabove. The volume averaged temperature is represented by T in units of eV. The values for T listed in Table for are in reference to peak operation volume average temperatures. The results from Scrape-off layer plasma simulation calculations (SOLPS) are also presented.

With reference to Table 6 and FIG. 7C, the parameters for this design are as follows: R_{div}=3.95 m 850, 1° Wet area=5.57 m², B Length=73.6, B Length gain=4.69, MA-m ratio=1.72. It is also apparent that more B length can be obtained by changing coil locations. It will be apparent that the location of the PF coils can direct and/or shape the SOL to the divertor plate, and thereby expand or reduce the particle flux (heat flux) coming from the SOL.

TABLE 6
Parameters for standard divertor, X divertor, and a disclosed
divertor (split into four divertors) for a reactor design.

| Div | B Angle | B Length | R_{div} | Max Area | T eV at | SOLPS |
|---|---|---|---|---|---|---|
| Plate | Degrees | [m] | [m] | m² (at 1°) | Peak | MW/m² |
| SD | 1.18 | 27.8 | 2.34 | 3.30 | 150 | 58 |
| XD | 0.92 | 40.3 | 2.51 | 3.54 | 150 | 28 |
| SXD | 1.0 | 73.6 | 3.95 | 5.57 | <5 | <18 |

For 5 mm wSOL at z = 0

FIG. 8 shows, for example, a cross section of an exemplary fusion development facility (FDF) 855 with a vertical height of about 7.15 m (1030) comprising components that can be used in a disclosed embodiment.

In this example, ohmic heating coils (OHCs) 945 are used to produce and/or heat the confined plasma, with a major plasma radius 920 of about 2.49 m, and with minor plasma radius of about 1.42 m. Extending from the central axis with a radius of about 1.78 m (930), is a blanket (i.e., the chamber walls) 940 that substantially encloses the plasma. The blanket shown is about 0.5 m thick.

The toroidal field (TF) center post 860 lies adjacent to the central axis, with a radius of about 1.2 m (1000), which is in physical communication with a TF wedge 880, the farthest radius of which extends about 4.35 m (1020) connected to TF outer verticals 890, the farthest radius of which extends about 5.72 m (1010). Exemplary poloidal field (PF) coils, 870, 900, and 910 inside the perimeter of the toroidal field, are positioned substantially adjacent to the fusion plasma. The distance 1040 between the two outermost (i.e., farthest away from the central axis) PF coils is about 1.0 m.

In this embodiment, a disclosed divertor plate 895 is shown substantially adjacent to a poloidal field coil 900. In the exemplary fusion reactor of FIG. 8, a standard divertor plate (SD) 950, as is known in the art, is shown in comparison to a disclosed divertor (SXD) 895. A standard divertor plate 950 configuration as shown in FIG. 8 can be used in combination with a disclosed divertor plate 895 configuration. It should be noted that the dimensions shown in FIG. 8 are exemplary in nature and variance of the dimensions or design of the fusion reactor is contemplated to be within the scope of various embodiments of the invention.

3. Modified Design of Future Machines

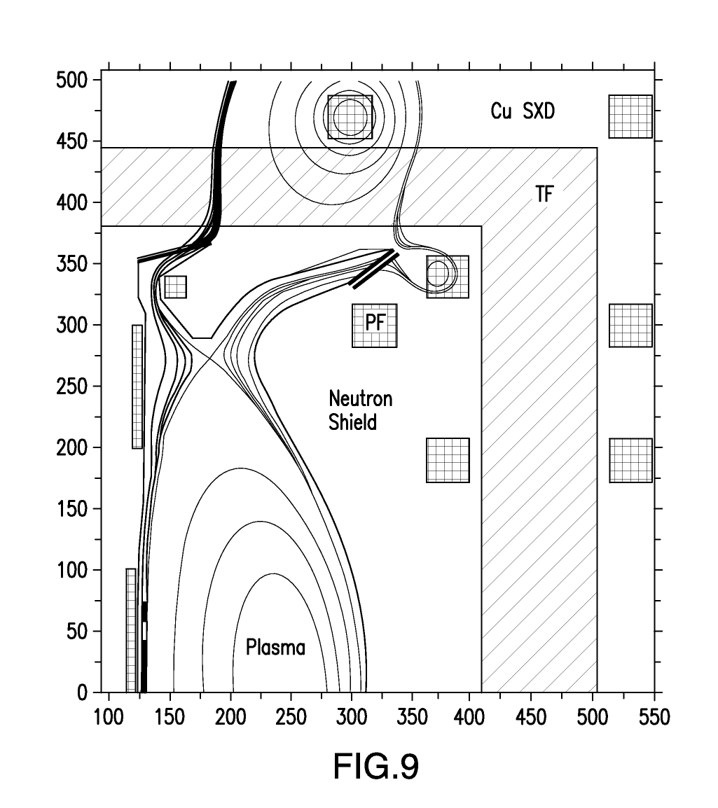

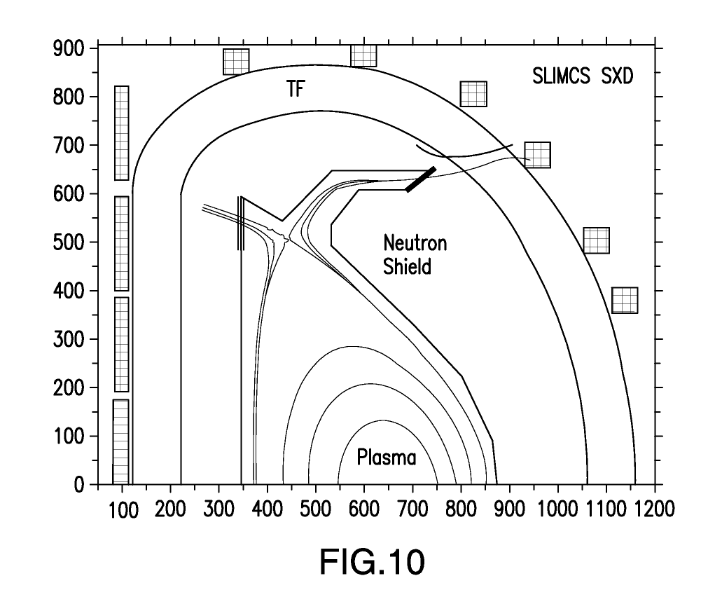

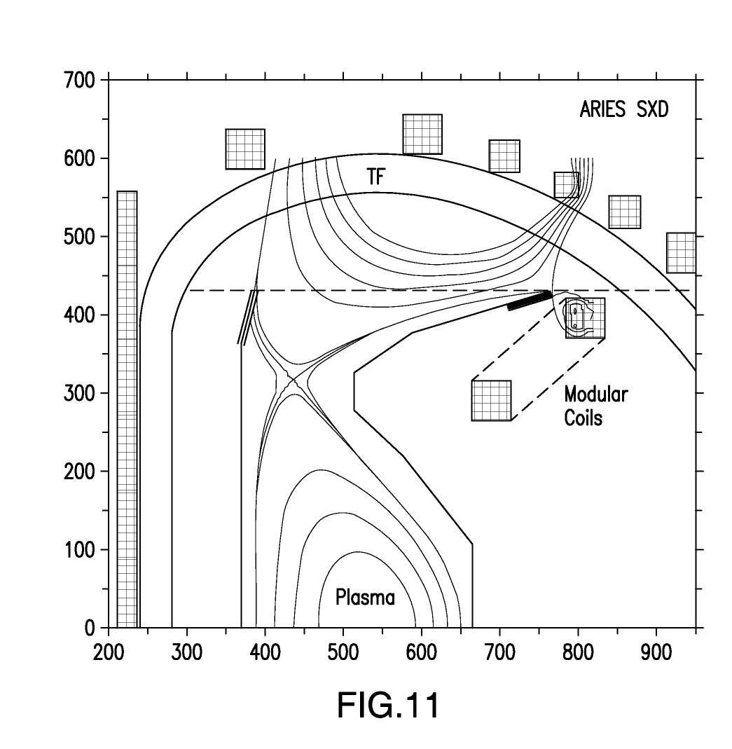

Using CORSICA™ (J. A. Crotinger, L. L. LoDestro, L. D. Pearlstein, A. Tarditi, T. A. Casper, E. B. Hooper, LLNL Report UCRLID-126284, 1997 available from NTIS PB2005-102154), MHD (magnetohydrodynamic) equilibrium can be generated for various future machine types, as presented herein. The results of a calculation for a Cu high power density (HPD) reactor are shown in FIG. 9. The results of a calculation for a superconducting (SC) SLIM-CS reactor with small radial build for TF (assuming remote handling ability) are shown in FIG. 10. The results of a calculation for an ARIES-AT reactor (also SC) with radially large TF coils are shown in FIG. 11. For the SLIM-CS design, it is apparent from FIG. 10 that an embodiment of a disclosed divertor design can be used wherein all poloidal field (PF) coils are outside toroidal field (TF) coils as is desirable for superconducting coils. The design shown in FIG. 11, however, uses modular SC (superconducting) divertor coils that fit inside unused volume in the reactor, thereby enabling larger radial divertor extension. For the configurations in FIGS. 9, 10, and 11, the gains in R_{div}/Rₛₒₗ are 2, 1.7, and 2, respectively, while the line length goes up (over a standard divertor, discussed in more detail in Kotschenreuther) by factors of 5, 3, and 4, respectively.

It should be appreciated that, through experimentation with CORSICA™ equilibria, a wide variety of plasma shapes (aspect ratios, elongations, triangularities, as defined hereinabove, etc.) can be accommodated with a disclosed embodiment. In some aspects, it is possible to modify the design of an existing or future reactor from a standard divertor design, to a disclosed divertor design with a small change in the number of coils and net applied power, while keeping the core plasma geometry substantially unaffected. Thus, in one aspect, a disclosed divertor design can be applied to a known reactor configuration.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Although several aspects of the present invention have been disclosed in the specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims which follow, they are used only in a generic and descriptive sense, and not for the purposes of limiting the described invention.

1. A toroidal plasma device, comprising:
a toroidal chamber about a central axis, wherein a toroidal core plasma is substantially confined within the toroidal chamber by closed magnetic field lines that stay substantially on closed toroidal magnetic surfaces, said closed magnetic field lines created by currents in the core plasma and in current-carrying conductors substantially adjacent to said toroidal chamber, wherein at least a portion of said current-carrying conductors comprises aluminum or an alloy thereof, and said toroidal core plasma is substantially enclosed by a region of open magnetic field lines that intersect one or more divertor plates; and
a separatrix comprising a magnetic surface that separates the core plasma and the region of open magnetic field lines, wherein said separatrix intersects the divertor plates such that particles and energy that flow from the core plasma across the separatrix into the region of open magnetic field lines are directed along the open magnetic field lines to the divertor plates, and
wherein the separatrix contains at least one stagnation point with a non-zero perpendicular distance from an equatorial plane, said equatorial plane perpendicular to the central axis and which passes through a point at a largest major radius in the core plasma, said perpendicular distance is greater than a plasma minor radius, and, said divertor plate has an outboard divertor major radius that is greater than a sum of the plasma minor radius and a major radius of a peak point closest to the corresponding divertor plate.

2. The toroidal plasma device of claim 1,
wherein a major radius of any point is its perpendicular distance from the central axis, and the equatorial plane, which is perpendicular to the central axis, and which passes through a point at a largest major radius in the core plasma, divides the toroidal chamber into upper and lower regions,
wherein the core plasma has an outer plasma major radius and an inner plasma major radius, said outer plasma major radius is the major radius of a point in the core plasma that is farthest from the central axis and said inner plasma major radius is the major radius of a point in the core plasma that is closest to the central axis,
wherein half of the sum of the outer and inner plasma major radii is a plasma major radius, and half of the difference between the outer and inner plasma major radii is the plasma minor radius,
wherein a point in the upper region of the core plasma farthest from the equatorial plane is an upper peak point and a point in the lower region of the core plasma farthest from the equatorial plane is a lower peak point,
wherein the largest major radius of points of intersection between the separatrix and the divertor plates is the outboard divertor major radius, and
wherein said separatrix has one or more stagnation points, each said stagnation point being a point where a poloidal component of a magnetic field that comprises said magnetic surface is about zero and where directions in any plane containing the central axis are poloidal.

3. The toroidal plasma device of claim 1, wherein the currents in the current-carrying conductors substantially adjacent to the toroidal chamber create a magnetic flux expansion in the region of open magnetic field lines that intersect the one or more divertor plates.

4. The toroidal plasma device of claim 3, wherein said magnetic flux expansion in the region of open magnetic field lines that intersect the one or more divertor plates spreads energy and particles transferred to the divertor plate over an expanded area of the divertor plate thereby decreasing average and peak fluxes of energy and particles incident on the one or more divertor plates.

5. The toroidal plasma device of claim 1, wherein currents in the current-carrying conductors substantially adjacent to the toroidal chamber increase magnetic connection length in the equatorial plane to the outboard divertor plate.

6. The toroidal plasma device of claim 5, wherein the increase in the magnetic connection length causes increased spreading or dissipation of energy before it is incident on the outboard divertor plate.

7. The toroidal plasma device of claim 1, wherein the particles coming from the core plasma cool to a temperature of less than about 40 electron volts before reaching the one or more divertor plates.

8. The toroidal plasma device of claim 4, wherein lower temperatures in proximity of the one or more divertor plates allows an increase in radiation of energy from the particles near the one or more divertor plates.

9. The toroidal plasma device of claim 5, wherein the magnetic connection lengths are long enough to maintain a stable zone of plasma at a temperature less than about 5 eV between the divertor plates and the core plasma.

10. The toroidal plasma device of claim 1, wherein at least one of the one or more divertor plates is substantially shielded from direct neutrons emitted from the toroidal core plasma.

11. The toroidal plasma device of claim 1, wherein said one or more divertor plates comprise liquid metal.

12. The toroidal plasma device of claim 1, wherein a ratio of total heating power in the core plasma to the plasma major radius is about 5 megawatts/meter or higher.

13. The toroidal plasma device of claim 5, wherein helium ash is pumped from fusion reactions, and wherein the major radius of the divertor plate is larger than the major radius of the nearest peak point by an amount greater than the plasma minor radius such that the device has an increase in neutral pressure near the divertor plate, decreased pumping channel lengths from the divertor plate to pumps, and an increased maximum area of pumping ducts.

14. The toroidal plasma device of claim 1, wherein the toroidal plasma device is a tokamak.

15. A method of exhausting heat and particles from a toroidal plasma device comprising:
creating a toroidal core plasma in a toroidal chamber about a central axis, wherein the toroidal core plasma is substantially confined within the toroidal chamber by magnetic field lines that stay substantially on closed toroidal magnetic surfaces, said closed magnetic field lines created by currents in the core plasma and in current-carrying conductors substantially adjacent to said toroidal chamber, wherein at least a portion of said current-carrying conductors comprises aluminum or an alloy thereof, and said toroidal core plasma is substantially enclosed by a region of open magnetic field lines that intersect one or more divertor plates; and
directing particles from the toroidal core plasma that cross said closed magnetic field lines to said open magnetic field lines to the one or more divertor plates, wherein at least one of the one or more divertor plates is placed at an outboard divertor major radius that is greater than or equal to a sum of a plasma minor radius and a major radius of the peak point closest to the corresponding divertor plate.

16. The method of claim 15, wherein creating a toroidal core plasma in a toroidal chamber about a central axis, wherein the toroidal core plasma is substantially confined within the toroidal chamber by magnetic field lines that stay substantially on closed toroidal magnetic surfaces comprises a separatrix comprising a magnetic surface that separates the core plasma and the region of open magnetic field lines, wherein said separatrix intersects the divertor plates such that particles and energy that flow from the core plasma across the separatrix into the region of open magnetic field lines are directed along the open magnetic field lines to the divertor plates,
wherein a major radius of any point is its perpendicular distance from the central axis, and an equatorial plane, which is perpendicular to the central axis, and which passes through a point at a largest major radius in the core plasma, divides the toroidal chamber into upper and lower regions, and
wherein the separatrix contains at least one stagnation point whose perpendicular distance from the equatorial plane is greater than the plasma minor radius.

17. The method of claim 15, wherein the core plasma has an outer plasma major radius and an inner plasma major radius, said outer plasma major radius is the major radius of a point in the core plasma that is farthest from the central axis and said inner plasma major radius is the major radius of a point in the core plasma that is closest to the central axis,
wherein half of the sum of the outer and inner plasma major radii is a plasma major radius, and half of the difference between the outer and inner plasma major radii is the plasma minor radius,
wherein a point in the upper region of the core plasma farthest from the equatorial plane is an upper peak point and a point in the lower region of the core plasma farthest from the equatorial plane is a lower peak point,
wherein the largest major radius of points of intersection between the separatrix and the divertor plates is the outboard divertor major radius, and
wherein said separatrix has one or more stagnation points, each said stagnation point being a point where a poloidal component of a magnetic field that comprises said magnetic surface is about zero and where directions in any plane containing the central axis are poloidal.

18. The method of claim 15, wherein the currents in the current-carrying conductors substantially adjacent to the toroidal chamber create a magnetic flux expansion in the region of open magnetic field lines that intersect the one or more divertor plates.

19. The method claim 18, wherein said magnetic flux expansion in the region of open magnetic field lines that intersect the one or more divertor plates spreads energy and particles transferred to the divertor plate over an expanded area of the divertor plate thereby decreasing average and peak fluxes of energy and particles incident on the one or more divertor plates.

20. The method of claim 15, wherein the currents in the current-carrying conductors substantially adjacent to the toroidal chamber increase magnetic connection length in the equatorial plane to the outboard divertor plate.

21. The method of claim 20, wherein the increase in the magnetic connection length causes increased spreading or dissipation of energy before it is incident on the outboard divertor plate.

22. The method of claim 15, wherein the particles coming from the core plasma cool to a temperature of less than about 40 electron volts before reaching the one or more divertor plates.

23. The method of claim 20, wherein lower temperatures in proximity of the one or more divertor plates allows an increase in radiation of energy from the particles near the one or more plates.

24. The method of claim 20, wherein the magnetic connection lengths are long enough to maintain a stable zone of plasma at a temperature less than about 5 eV between the divertor plates and the core plasma.

25. The method of claim 15, wherein at least one of the one or more divertor plates is substantially shielded from direct neutrons emitted from the toroidal core plasma.

26. The method of claim 15, wherein said one or more divertor plates comprise liquid metal.

27. The method of claim 15, wherein a ratio of total heating power in the core plasma to the plasma major radius is about 5 megawatts/meter or higher.

28. The method of claim 15, further comprising pumping of helium ash from fusion reactions, wherein the major radius of the divertor plate is larger than the major radius of the nearest peak point by an amount greater than the plasma minor radius such that the device has an increase in neutral pressure near the divertor plate, decreased pumping channel lengths from the divertor plate to pumps, and an increased maximum area of pumping ducts.

29. The method of claim 15, wherein the toroidal plasma device is a tokamak.

30. A compact fusion neutron source comprising:
a high power density toroidal plasma device;
wherein said toroidal plasma device has a ratio of total heating power in a core plasma to a plasma major radius of about 5 megawatts/meter or higher,
wherein said toroidal plasma device has a total power of neutrons crossing a surface of the core plasma of about 0.1 megawatts per meter squared per second, or higher,
wherein said toroidal plasma device comprises a system of current-carrying coils for generating and shaping a magnetic field in the toroidal plasma device,₋herein at least a portion of said current-carrying coils comprises aluminum or an alloy thereof, and
wherein said toroidal plasma device has one or more divertor plates located at an outboard divertor major radius that is greater than or equal to a sum of a plasma minor radius and a major radius of a peak point closest to the corresponding outboard divertor plate.

31. The compact fusion neutron source of claim 30, wherein the toroidal plasma device is a tokamak.

32. A device comprising:
a chamber enclosed by walls about a central axis, wherein said chamber has an inner radius and an outer radius relative to the central axis and is configured to contain a core plasma by magnetic fields;
a system of current-carrying coils for generating and shaping said magnetic fields, wherein at least a portion of said current-carrying coils comprises aluminum or an alloy thereof and
a divertor plate configured for receiving exhaust heat, said divertor plate having a divertor radius relative to the central axis and said divertor radius greater than or equal to the sum of a plasma minor radius and a major radius of the peak point closest to the corresponding divertor plate.

33. The device of claim 32, wherein a core plasma contained within the chamber has an outer plasma major radius and an inner plasma major radius, said outer plasma major radius is the major radius of a point in the core plasma that is farthest from the central axis and said inner plasma major radius is the major radius of a point in the core plasma that is closest to the central axis,
wherein half of the sum of the outer and inner plasma major radii is a plasma major radius, and half of the difference between the outer and inner plasma major radii is the plasma minor radius,
wherein a point in the upper region of the core plasma farthest from the equatorial plane is an upper peak point and a point in the lower region of the core plasma farthest from the equatorial plane is a lower peak point,
wherein a largest major radius of points of intersection between the separatrix and the divertor plates is an outboard divertor major radius, and
wherein said separatrix has one or more stagnation points, each said stagnation point being a point where a poloidal component of a magnetic field that comprises said magnetic surface is about zero and where directions in any plane containing the central axis are poloidal.

34. The device of claim 32, wherein the core plasma is substantially confined within the chamber by closed magnetic field lines that stay substantially on closed magnetic surfaces, said closed magnetic field lines created by currents in the core plasma and in said system of coils, and said core plasma is substantially enclosed by a region of open magnetic field lines that intersect the divertor plate.

35. The device of claim 34, wherein currents in said system of coils create a magnetic flux expansion in the region of open magnetic field lines that intersect the divertor plate.

36. The device of claim 32, wherein said magnetic flux expansion in the region of open magnetic field lines that intersect the divertor plate spreads energy and particles transferred to the divertor plate over an expanded area of the divertor plate thereby decreasing average and peak fluxes of energy and particles incident on the divertor plate.

37. The device of claim 33, wherein currents in said system of coils increase magnetic connection length in the equatorial plane to the divertor plate.

38. The device of claim 37, wherein the increase in the magnetic connection length causes increased spreading or dissipation of energy before it is incident on the divertor plate.

39. The device of claim 32, wherein the particles coming from the core plasma cool to a temperature of less than about 40 electron volts before reaching the divertor plate.

40. The device of claim 32, wherein lower temperatures in proximity of the divertor plate allows an increase in radiation of energy from the particles near the divertor plate.

41. The device of claim 37, wherein the magnetic connection length is long enough to maintain a stable zone of plasma at a temperature less than about 5 eV between the divertor plate and the core plasma.

42. The device of claim 32, wherein the divertor plate is substantially shielded from direct neutrons emitted from the core plasma.

43. The device of claim 32, wherein the divertor plate comprises liquid metal.

44. The device of claim 32, wherein a ratio of total heating power in the core plasma to the plasma major radius is about 5 megawatts/meter or higher.

45. The device of claim 37, wherein helium ash is pumped from fusion reactions within the chamber, and wherein the major radius of the divertor plate is larger than the major radius of the nearest peak point by an amount greater than the plasma minor radius such that the device has an increase in neutral pressure near the divertor plate, decreased pumping channel lengths from the divertor plate to pumps, and an increased maximum area of pumping ducts.

46. The device of claim 32, wherein said device comprises at least a portion of a tokamak.
